(19) United States
(12) Patent Application Publication
(10) Pub. No.: US 2017/0122362 A1
(43) Pub. Date: May 4, 2017

(54) FASTENER RETENTION AID APPLICATION APPARATUS AND RELATED METHOD

(71) Applicant: ND Industries, Inc., Clawson, MI (US)

(72) Inventors: Gerald F. Snow, Almont, MI (US); Christopher T. Hable, Romeo, MI (US)

(21) Appl. No.: 15/298,682

(22) Filed: Oct. 20, 2016

Related U.S. Application Data
(60) Provisional application No. 62/247,494, filed on Oct. 28, 2015.

(51) Int. Cl. F16B 43/00; C09J 177/00; B29C 65/00; C09J 175/04; B29C 65/48; C09J 5/04; C09J 123/02

(52) U.S. Cl. CPC F16B 43/00; C09J 5/04; C09J 177/00; C09J 123/02; C09J 175/04; B29C 65/4845; B29C 66/5324; B29L 2001/002

(57) ABSTRACT

An apparatus and method that apply retention aid material to an inner diameter of an apertured part, such as a washer, a collar or the like. The method can include: moving a apertured parts linearly, optionally horizontally, along a conveyor, each apertured part defining an aperture and including upper surface and opposing lower surfaces with an inner diameter surface therebetween; dispensing a liquid retention aid material from a dispenser so that the material engages and/or spatters against the inner diameter surface as the apertured parts move linearly, optionally horizontally, along the conveyor; and curing the material to join it with the inner diameter surface, thereby forming a resilient retention aid projection extending inward from the inner diameter surface. The apparatus can perform the method, which can include seeping the material under the lower surface to form a seepage portion. An apertured part with a retention aid is also provided.

### BACKGROUND OF THE INVENTION

The present invention relates to an apparatus and method that apply an assembly retention aid to an apertured part, and more particularly to an apparatus and method that apply retention aid material to an inner diameter of an apertured part, such as a washer, a collar or the like.

In a variety of manufacturing operations, it can be helpful to assemble certain components and fasteners before the same are incorporated into assemblies, machines or other articles at a distant location. For example, an elongated, cylindrical collar can be applied to a complementary fastener, such as a bolt, before the bolt is mated with a nut in a subsequent operation. In this procedure, it can be helpful to have the collar remain attached to the complementary fastener so that the two can be transported as a one piece unit to another location for further assembly with other components. To ensure this attachment, a retention tab can be secured to the inner diameter of the collar. When the collar is installed on a fastener, the retention tab engages the fastener to hold the collar on the fastener.

Some manufacturers have developed specialized techniques and machinery to apply a retention tab to an inner diameter of the collar. In one technique, multiple collars travel on a non-linear carousel that rotates about a central axis in a circular path. Each collar is disposed at a non-horizontal angle, for example, 45° from horizontal, about the carousel and around the axis on support plates disposed at about the same angle. Powdered resin is dumped into the interiors of the collars one by one. The powdered resin settles at the bottom of the collar adjacent a support plate. Because the collar is tilted at the angle, the powdered resin forms a wedge shape at the bottom of the collar near the inner diameter. The powdered resin is then cured with heat so that it turns into a solid, wedge-shaped retention tab on the inner diameter of the collar.

While the above technique and machinery can form retention tabs on certain elongated cylindrical collars, they are not well-suited for shorter collars and other flattened, apertured parts, such as washers, nor do they work well for the application of other flowable materials to form the retention tabs. Therefore, there remains room for improvement to apply different retention tab materials to a variety of apertured parts, such as washers and collars.

### SUMMARY OF THE INVENTION

An apparatus and method that apply retention aid material to an inner diameter of an apertured part, such as a washer, a collar and the like is provided. The resulting part has a resilient and/or semi-rigid retention aid projection extending inwardly from an inner surface diameter of an aperture of the apertured part.

In one embodiment, the method can include: moving apertured parts linearly, optionally horizontally, along a conveyor, each apertured part defining an aperture and including upper surface and an opposing lower surface with an inner diameter surface therebetween; dispensing a liquid retention aid material from a dispenser so that the material engages, globs and/or spatters against the inner diameter surface as the apertured part moves linearly, optionally horizontally, along the conveyor; and curing the material to join it with the inner diameter surface, thereby forming a retention aid projection extending inward from the inner diameter surface.

In another embodiment, the method can include seeping the material under the lower surface to form a seepage portion optionally on a lower surface of the part.

In still another embodiment, the method can include dispensing liquid retention aid material from a dispenser, such as a dispense gun module, toward a conveyor as an apertured part, such as a washer, approaches a point of impact of the material along the conveyor. The material can be dispensed before or at the same time as a leading edge of the washer passes under the dispenser. During the time it takes for the material to dispense into the aperture, the washer can move dynamically along the conveyor and relative to the dispenser so that the material precisely engages a trailing edge or trailing portion of an inner diameter surface of the washer, but not a leading portion of the inner diameter surface. Optionally, the dispenser can dispense the material with compressed air so that the material is projected along a trajectory, toward the aperture and/or conveyor.

In even another embodiment, the liquid retention aid material can engage an upper surface of the conveyor, optionally including conveyor belt media having one or more release agents. The material also can collide with the inner diameter surface of the apertured part, with that surface acting as a backstop so that the material engages it and extends upwardly a distance toward the upper surface of the apertured part.

In still another embodiment, the method can include engaging multiple apertured parts as they are conveyed along the conveyor with a feed wheel. The feed wheel can engage at least the upper surface of the horizontally positioned apertured parts, and can provide appropriate metering and/or spacing of one apertured part relative to the next, so that material can be properly dispensed relative to each of the apertured parts.

In a further embodiment, the method can include providing a bed of North-South pole magnets positioned under or adjacent the conveyor. The bed can include a first set of magnets on one side of a centerline of the conveyor, with only north or only south poles facing toward the centerline, and a second set of magnets on an opposing side of the centerline of the conveyor, with the same north or south poles facing toward the centerline as the first set of magnets. A nonmagnetic strip of material, such as brass, can be disposed between the first and second sets of magnets. Cooperatively, the sets of magnets in the bed can exert a magnetic field that moves the apertured parts relative to and/or about a centerline of the conveyor bed, particularly when the aperture parts are constructed from metal.

In still a further embodiment, the method can include utilizing one or more sensors to activate one or more dispensers, such as gun modules, to apply liquid retention aid material onto the apertured parts.

In yet a further embodiment, the method can include providing the liquid retention aid material in the form of a UV/EB curable material such as at least one of acrylate, methacrylate, vinyl functional monomers and oligomers and similar materials. Other liquid retention aid materials can include hot melt adhesives, polyolefins, polyamides, polyurethane adhesives and the like. In some cases, powdered or particulate versions of the foregoing can be used as well in certain application. These materials can be formulated to provide desired flexibility and/or rigidity in a formed and cured retention aid projection, and/or to increase or decrease the hardness of the same.

In an even further embodiment, the method can include curing the retention aid material with a preselected wavelength of light, optionally in the 200 to 600 nm range, for a preselected amount of time as a particular apertured part passes by a curing station.

In another, further embodiment, the apparatus can perform the steps of any of the method embodiments herein. The apparatus can include a feed station, for example a vibratory feeder bowl or rotary feeder bowl, that feeds, orients and/or meters apertured parts, such as washers or collars onto a conveyor, which can move the multiple apertured parts in a sequential, single file manner toward and past a dispensing station, including for example, a gun module. Optionally, the apparatus can include a metering device that spaces and/or meters apertured parts relative to one another so they have a consistent distance separating the same. One or more adjustment guides can be utilized to adjust the apertured parts into a particular alignment relative to a centerline of the conveyor.

In still another, further embodiment, the apparatus can include a curing station that cures dispensed liquid retention aid material so that it at least partially solidifies, forming a resilient and/or semi-rigid projection that extends inwardly from an inner diameter surface of the apertured part, optionally toward an axis of the apertured part. The curing station can include one or more UV irradiators that emit a preselected wavelength of light in the 200 to 600 nm range.

In even another embodiment, the apparatus can include a pre-heat station, when the application of liquid retention material involves the dispensing of hot melt materials. The preheat station can be located between the feed station and the dispensing station so that the apertured parts are brought to a satisfactory, elevated temperature before the hot melt materials are dispensed and engage the pre-heated, apertured part.

In still another embodiment, the apparatus can include a curing station that cures dispensed liquid retention aid material in the form of hot melt materials. This curing station can include a water chilled system that dispenses a cooled liquid, such as water, over the apertured parts after the application of the retention aid material. In other applications, the curing station can include a blower and a source of chilled air, where the blower blows chilled air over the apertured parts after the application of the retention aid material.

In yet another, further embodiment an apertured part is provided. The apertured part can include a part body and a retention aid body. The retention aid body can be joined with an inner circumferential edge of the part body, and can extend inward toward an aperture axis, or a washer axis, a preselected distance. The retention aid body can include a flexible free end adapted to engage a complimentary part inserted through the aperture. Optionally, the retention aid body can include a seepage portion that extends outwardly, beyond the inner circumferential edge toward the outer circumferential edge. This seepage portion can be joined with the lower surface of the apertured part, optionally only at or near a rear half of the part body.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a top plan view of equipment adapted to apply retention aid material to an apertured part according to a current embodiment;

FIG. 2 is a side view of the equipment;

FIG. 3 is a section view of the equipment illustrating an underlying magnetic bed disposed adjacent a conveyor that conveys multiple apertured parts;

FIG. 4 is a top view of the equipment illustrating a metering wheel and an adjustable guide associated with the conveyor;

FIG. 5 is a top view of a retention aid material dispensing station of the equipment;

FIG. 6 is another view of the retention aid material dispensing station;

FIG. 7 is a close-up side view of the dispensing station beginning to drop retention aid material as an apertured part dynamically moves through the station;

FIG. 8 is a close-up side view of the drop as it moves toward the conveyor as the apertured part dynamically moves through the station;

FIG. 9 is a close up view of the retention aid material as it engages against the conveyor and the inner diameter surface of the apertured part;

FIG. 10 is a top view of an apertured part in the form of a washer constructed with a current embodiment of the machinery and a related method;

FIG. 11 is a bottom view of thereof;

FIG. 12 is a section view of thereof;

FIG. 12A is a view of a three tab washer constructed according to the current embodiments herein, and subjected to a push test with a threaded fastener;

FIG. 12B is a view of a two tab washer constructed according to the current embodiments herein, and subjected to a push test with a threaded fastener;

FIG. 12C is a view of a one tab, “Tab Up” washer constructed according to the current embodiments herein, and subjected to a push test with a threaded fastener;

FIG. 13 is a side view of machinery of a first alternative embodiment including a magnetic or other flipping apparatus to turn apertured parts over so that an additional amount of retention aid material can be joined with the apertured part;

FIG. 14 is a top view of an apertured part constructed with the first alternative embodiment of the machinery and a related method;

FIG. 15 is a bottom view thereof;

FIG. 16 is a section view thereof;

FIG. 16A is a perspective view of the apertured part installed on an elongated fastener;

FIG. 17 is a side perspective view of machinery of a second alternative embodiment including a conveyor that conveys apertured parts in a vertical orientation so that a dispenser can dispense retention aid material into the aperture of the apertured part while the apertured part is generally vertical;

FIG. 17A is a side perspective view of machinery of a variation of a second alternative embodiment including a conveyor that conveys apertured parts in a vertical orientation, outer diameter to outer diameter;

FIG. 18 is a section view of a retention aid material applied with the machinery of the second alternative embodiment, extending generally from a first outer surface of the apertured part to a second opposing outer surface of the apertured part;

FIG. 19 is a top plan view of equipment of a third alternative embodiment adapted to apply hot melt material to an apertured part;

FIG. 20 is a side view of the equipment of the third alternative embodiment;

FIG. 21 is a close up side view of a transition station of the equipment that flips apertured parts over automatically; and

FIG. 22 is a close up side view of an end of the equipment of a fourth alternative embodiment adapted to apply retention material to a nonmagnetic-apertured part.

### DESCRIPTION OF THE CURRENT EMBODIMENTS

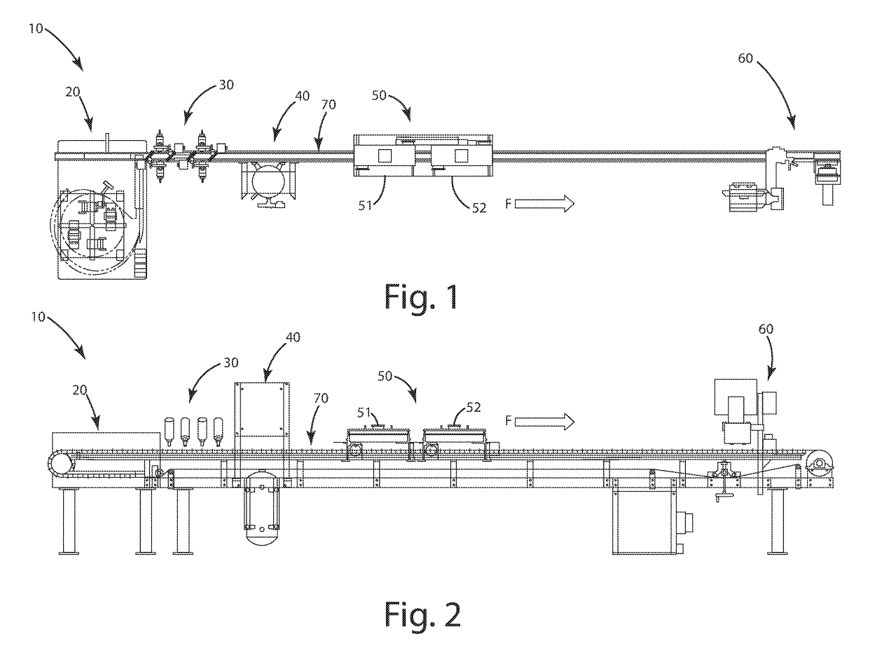

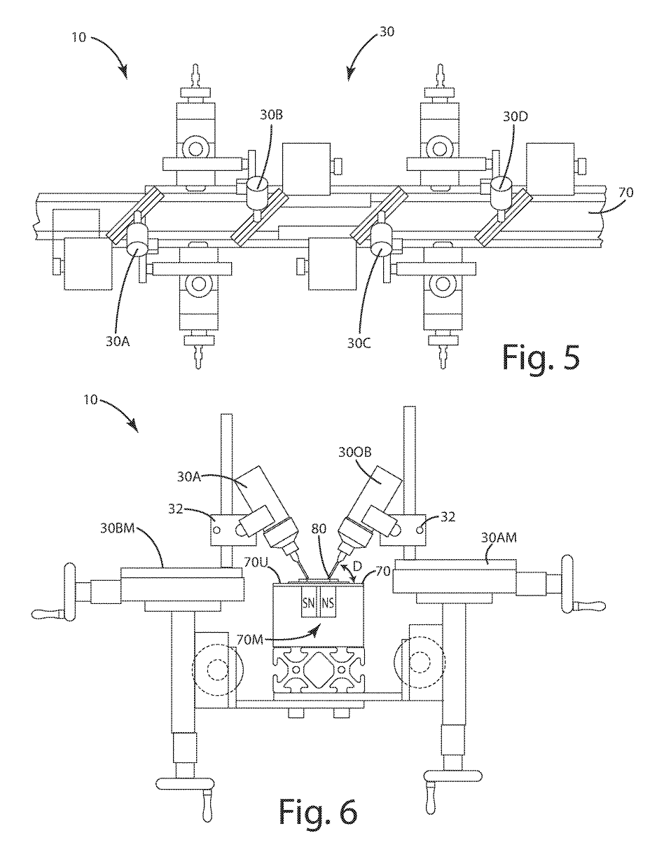

A method and related apparatus for performing the method will now be described in connection with FIGS. 1-12. As shown in FIGS. 1 and 2, a retention aid application apparatus 10 is provided. The apparatus 10 generally includes a feed station 20, a retention aid material dispensing station 30, a control station 40, a curing station 50 and an optional inspection station 60. The apparatus also includes a conveyor 70 that conveys apertured parts past the various stations along a substantially horizontal pathway.

For purposes of simplicity, the embodiments herein will be described in connection with washers, however, it will be appreciated that any other apertured part, such as collars, short tubes or other similar parts, can likewise be processed via the apparatus and method. The washers 80 herein can have particular features. For example, with reference to FIGS. 10-12, each washer 80 can include an upper surface 80U and an opposing lower surface 80L. Each apertured part can include an aperture 80A extending from the upper surface to the lower surface of the washer, basically forming a hole therethrough. Although shown as generally centered on a central washer axis WA, the aperture 80A in some cases can be offset relative to the washer axis WA some amount or distance. Further, the washer 80 can include an outer diameter surface 80O and an inner diameter surface 80I. The inner diameter surface 80I can be a generally vertical wall that circumferentiates the aperture 80A Likewise, the outer diameter surface 80O can be a vertical wall that circumferentiates the outermost portion of the washer body 80B. The outer diameter surface 80O can optionally form an outer circumferential edge forming an outer boundary of the part body 80B, the upper surface 80U and/or the lower surface 80L. The inner diameter surface 80I also can form an inner circumferential edge forms an inner boundary of at least one of the part body 80B, the upper surface 80U and the lower surface 80L. The washer axis WA can correspond to an aperture axis which itself generally corresponds to a center of the aperture in some constructions.

Each washer 80, when conveyed on a conveyor, can include respective leading and trailing edges of the respective inner diameter surface and outer diameter surface. For example as shown in FIG. 11, when a washer 80 is conveyed in a direction of flow F, the outer diameter leading edge 80OLE is the forward most portion of the washer along the conveyor. The inner diameter surface leading edge 80ILE is the next portion of the washer 80 in the direction of flow F. Trailing this leading edge 80ILE is an inner diameter surface trailing edge 80ITE. Yet further behind the inner diameter surface trailing edge 80ITE is the outer diameter trailing edge 80OTE, which basically is the portion of each washer that last passes any station of the apparatus 10. As will be described in further detail below, the trailing edge of the inner diameter surface 80ITE is the primary portion of the washer 80 with which the liquid retention aid material is joined in certain applications. In some cases the washer can have a thickness between the upper surface of the lower surface of less than optionally ½ inch, further optionally less than ¼ inch, and even further optionally less than ⅛ inch.

With a description of one kind of apertured part suitable for use with the apparatus 10 described, explanation of the illustrated apparatus will resume. The feed station 20 can be any vibratory and/or rotary feeder bowl or other feeder device that is adapted to feed apertured parts onto the conveyor 70. The feed station 20 feeds and orients the washers so that they lay flat against the conveyor 70, and so that the conveyor can convey those washers along a horizontal pathway, with the washers each laying generally horizontally throughout their entire conveyance along the conveyor. In this configuration, the washer axis WA is generally perpendicular to an upper surface of the conveyor along the entire pathway through the apparatus 10 on the conveyor 70.

The conveyor 70 can be in the form of a linear belt conveyor, with an upper surface 70U that is oriented in and travels within a substantially horizontal plane, and therefore along a substantially horizontal pathway. Of course in some cases the upper surface can be slightly offset from a true horizontal plane, for example, optionally about 0° to about 5°, and further optionally about 1° to about 5°, even further optionally about 1° to about 3°, with the washers moving along a similar path, and with the washers still travelling in what is considered herein a substantially horizontal plane. If there is no offset, the washers can travel in the true horizontal plane. When traveling along the substantially horizontal pathway, the upper and/or lower surfaces of the washer can be parallel to the substantially horizontal plane as well.

The conveyor can be constructed so that the upper surface 70U of its belt or support surface includes a release agent and/or release layer that facilitates the release of a variety of polymeric and other materials from the conveyor with minimal to zero force. As an example, the release agent or layer can be or can include polytetrafluoroethylene (PTFE), commercially available under the trade name, Teflon®, perfluoroalkoxy polymer resin (PFA), fluorinated ethylene propylene (FEP) or similar materials that have a low propensity to chemically and/or mechanically bond with liquid and/or solid materials placed thereon. The conveyor belt and/or its components can be constructed from the release agent. Alternatively, a coating, layer or parts of the release agent can be applied to the structure of the conveyor and/or its components.

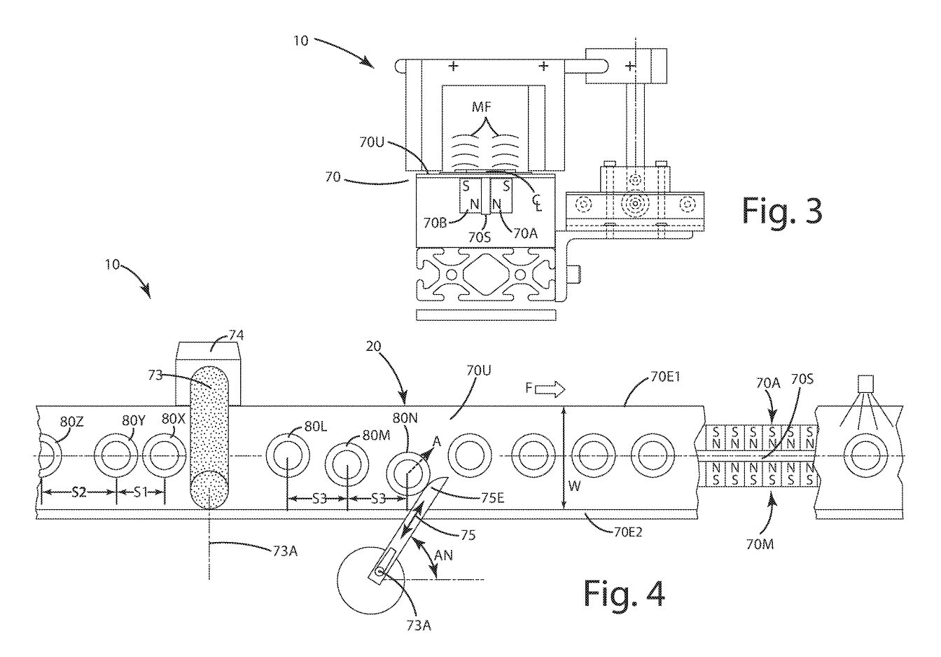

The conveyor 70 can be constructed to include a magnetic bed 70M that exerts one or more magnetic fields MF (FIG. 3) to assist in centering the washers along a center line CL of the conveyor 70. With the magnetic forces MF exerted upon the effective washers, the washers can be urged toward the center line CL of the conveyor 70, optionally due to the polarity and/or configuration of the magnets within the magnetic bed 70M. Optionally the conveyor can include a width W spanning between a first edge 70E1 and a second edge 70E2. The washers can be urged toward a preselected location between the first and second edges using the magnetic bed 70M of the conveyor, and/or the adjustment guides 75 as described below.

As shown in FIGS. 3 and 4, the magnetic bed 70M can include first 70A and second 70B sets of North-South Pole magnets disposed on opposite sides of a center line CL of the conveyor 70. These magnets can be C8 magnets, ceramic magnets, neodymium magnets, samarium cobalt magnets or other types of magnets depending on the application. The first and second sets of magnets can be oriented so that the South poles of all magnets in the first set 70A and second set 70B face toward the center line CL and toward one another, or so that the North poles of all magnets in the first set and the second set face toward the center line CL and toward one another. A nonmagnetic strip 70S of material, such as brass, can be disposed between the first and second sets of magnets. The first and second sets of magnets and the nonmagnetic strip can be disposed along the entire functional length of the conveyor. This configuration can again exert the magnetic fields MF that provide center metal apertured parts placed on the conveyor upper surface 70U. As illustrated, the magnetic bed 70M generally centers the metal apertured washers along the centerline of the conveyor. Of course, the magnetic bed can be moved off center so as to align the washers at some other axis parallel to and/or offset from the centerline CL of the conveyor 70.

Generally, when the washers 80 are fed onto the conveyor 70, their upper surfaces 80U face upward and their lower surfaces 80L face downward and contact the upper surface 70U of the conveyor, which again can include a release agent. Sometimes, the lower surface 80L of the washers can include imperfections and/or can be un-smooth or porous. In this case, the lower surfaces 80L of the washers do not fully contact the release agent and/or the upper surface 70U of the conveyor. In such a case, there can be a small cavity or space formed under the washer 80, generally between the upper surface 70U of the conveyor and the lower surface 80L of the washer. This space can be largest in the region near the inner diameter surface 80I. Generally, this space can be optimally 0.001 inches to 0.2 inches, and further optimally 0.01 inches to 0.1 inches. As explained below, this space can facilitate the seeping of liquid retention aid material under the washer, adjacent the lower surface and/or between the lower washer surface 80L and the upper surface 70U of the conveyor and/or release agent.

As mentioned above and shown in FIG. 4, the conveyor 70 conveys the washers 80 along a substantially horizontal pathway. In some cases, the spacing of the washers can be imprecise and inconsistent. For example, spacing between washers 80X and 80Y can be at a particular spacing 51, while the spacing between washers 80Y and 80Z can be a second, different spacing S2. This erratic and/or random spacing along the conveyor can make it difficult to consistently apply retention aid material to the washers at specific locations at the dispensing station 30. Therefore, the apparatus and method can include and implement a feed wheel 73. This feed wheel can be mounted to an adjustable motor and/or clutch 74. The feed wheel 73 can rotate about an axis 73A, which is disposed generally parallel to the upper surface 70U of the conveyor and transverse or perpendicular to the centerline CL of the conveyor 70. The feed wheel 73 can include an outer surface that is spaced to contact the upper surfaces of each horizontally positioned washer, for example the upper surfaces of washers 80X, 80Y and 80Z. The feed wheel rotates at a preselected RPM to properly meter and/or space each washer as they pass under the feed wheel. As an example, the feed wheel contacts the washers 80L, 80M and 80N that are moved by the conveyor 70. Upon this contact, the wheel, rotating at a slower or different rate than the underlying conveyor moves linearly, to move the washers relative to the conveyor and space them at a consistent distance S3 from one another. With the washers 80 consistently spaced, they are less prone to feed too close to one another through the dispensing station 30 or to make contact with one another in such a manner that they do not trigger sensors along the conveyor to allow the stations to function properly. The feed wheel can be modified and/or moved so that different sized and shaped washers can be metered spaced consistently from one another. Optionally, the feed wheel can be constructed from foam, rubber, silicone and other low durometer, compressible materials.

The apparatus 10 and related method can implement certain adjustment guides 75, also referred to as bumpers, belt guides and/or part guides. These bumpers 75 can include an end 75E that engages washers being conveyed along the conveyor 70. The adjustment guides can project outwardly and over the upper surface 70U of the conveyor. The adjustment guides also can include an adjustment mechanism 75A that allows the guide 75 to be disposed at any angle AN relative to the centerline CL of the conveyor.

Generally the adjustment guide can be oriented to precisely position each washer on the conveyor for subsequent application of the retention aid material at the dispensing station. As one example, upon exit of the feed wheel 73, sometimes washers can be aligned horizontally to the left or right of the centerline CL of the conveyor 70. The adjustment guide 75 can engage each individual washer with its end 75E, which optionally can be rounded and/or angled, to alter the direction of the washer into direction A. This, in turn, bumps the washers toward the centerline CL of the conveyor. Alternatively, of course, the adjustment guide can be fitted on the opposite side of the conveyor to reposition certain washers horizontally toward the centerline of the conveyor in a different direction. Each guide 75 can be mechanically adjustable within a horizontal plane, as well as vertically, to accommodate varying dimensioned and thickness washers. Optionally, the adjustment guide 75 can be used in case the magnetic bed 70M fails, or in some constructions, the magnetic bed 70M can be completely absent, with the adjustment guides performing the lateral movement of the washers relative to the centerline CL of the conveyor 70 so that they are properly aligned with dispensers in the dispensing station.

After the washers 80 are precisely positioned and/or spaced along the linear conveyor 70, optionally utilizing the feed wheel 73, magnetic bed 70M and/or adjustment guide 75, the conveyor 70 moves the washers 80 toward the dispensing station 30. Optionally, the washers can pass by series of sensors, such as fiber-optic sensors that time the precise application of retention aid material from the dispensers. Each sensor optionally can be used to signal, through a relay, a solenoid valve disposed in individual dispensers, 30A, 30B, 30C and 30D that are disposed adjacent and over the respective portions of the conveyor, generally along a centerline CL of the conveyor. The dispensers optionally can be in the form of a zero cavity gun module and/or diaphragm style dispensing valve. Of course, other types of dispensers, such as eccentric screw applicators for dispensing viscous and/or liquid materials, can be used in the apparatus and method herein.

The respective individual dispensers, 30A 30B, as shown in FIG. 6, can be oriented at an angle D relative to the conveyor and more particularly the horizontal upper surface 70U of the conveyor 70. This angle D can be optionally 30° to 60°, further optionally 15° to 45°, and even further optionally 20° to 35°, depending on the application. In other applications, the angle D can be 80° to 90°, so that the dispenser is held generally vertically over washers passing along the conveyor 70. The dispenser can be associated with bracketry 32 that can provide rough angular adjustment. This rough angular adjustment, coupled with fine horizontal and vertical adjustment, provided via adjustment mechanisms 30AM and 30BM, can enable an operator to precisely apply the retention aid material from the dispensers into a desired location within an aperture and/or against an inner diameter surface of each washer as it passes through the dispensing station 30.

In some cases, there can be four separate sensors, each associated with the four respective dispensers 30A, 30B, 30C and 30D. The sensors can trigger dispensing of the retention aid material from the respective dispensers. Optionally, the dispensers and sensors can have a staggered position, with two sensors and two dispensers mounted to the right hand side of the centerline CL of the conveyor, and two other sensors and associated dispensers mounted to the left hand side of the centerline CL of the conveyor. Each respective sensor can have fine and/or rough horizontal and vertical adjustment mechanisms that enable proper positioning along the conveyor. The respective dispensers 30A, 30B, 30C and 30D also can have fine and/or rough horizontal and vertical adjustment mechanisms that precisely position the dispensing ends 30E of each dispenser in proper alignment with the respective washers.

Optionally, the sensors and dispensers can be configured to actuate or not actuate as each washer passes by the sensor. If desired, the precise timing of dispensation of the material from a dispenser can be adjusted relative to the sensing event through a control 40 of the apparatus. This control can be a touchscreen and/or human machine interface that enables the operator to adjust certain parameters of the apparatus, for example conveyor speed, sensor sensitivity, feed wheel rotation rate, material dispensing timing, adjustment guide orientation, curing irradiation intensity and/or wavelength at the curing station 50, and/or other parameters depending on the application.

In some applications, the different dispensers can be utilized in different combinations. For example in some cases, only the first dispenser 30A and its associated sensor can be configured to dispense material onto washers. The remaining dispensers 30B, 30C and 30D and their associated sensors can be idle, and not dispense any material. As another example, every dispenser 30A-30D can be activated so that each associated dispenser dispenses material to respective washers along the conveyor under the respective dispensers. In yet other examples, one sensor and a first dispenser can be utilized for the application of liquid retention aid material on a first portion of the washer, while a second dispenser and sensor can be utilized for the application of liquid retention aid material on a second portion of the same washer, distal from the first portion, for a two shot application.

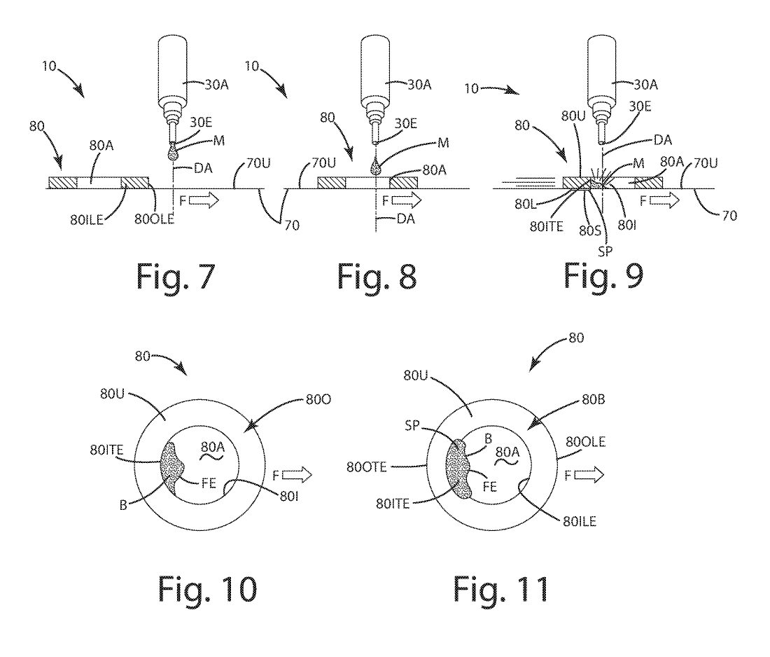

As shown in FIGS. 1, 5 and 6, the dispensing station 30 and its dispensers are located above and adjacent the conveyor 70. Generally, the dispensing station 30 is adapted to dispense liquid retention aid material in a sequential manner so that an amount of retention aid material free falls through air toward the conveyor and in to the respective apertures of the washers, so as to engage an inner diameter surface 80I of the aperture. For example, with reference to FIGS. 7-9, the dispenser 30A is positioned above a conveyor upper surface 70U. A washer 80 is conveyed along the conveyor 70. An amount M of retention aid material, optionally in liquid and/or flowable form, but generally not in powdered, particulate or solid form, is dispensed from an end 30E of the dispenser 30A. The material M can form one or more droplets or short streams as illustrated. The amount of material M can begin to exit the end 30E of the dispenser 30A before the leading edge 80OLE and/or inner surface diameter leading edge 80ILE passes through or by a drop axis DA along which the amount of material M is projected, either forcefully under the force of compressed air or a mechanical ejector, and/or via gravity in particular applications. Of course, in some cases both the edges can be past the dropping axis DA in some applications, particularly with very large washers.

As shown in FIG. 8, the material M continues to move along the drop axis DA as the washer 80 moves dynamically past the and 30E of the dispenser 30A, the material M in this case can enter the aperture 80A of the washer, while the washer is moving through and/or past the drop axis DA in the direction of flow F.

As shown in FIG. 9, as the washer 80 moves in the direction of flow F, eventually, the amount of material M enters the aperture 80A and falls to the upper surface 70U of the conveyor 70, engaging and/or colliding with that element. The material M, being in liquid or and/or flowable form, also engages and/or collides with the at least a portion of the inner diameter surface 80I. In particular, the material M optionally can spatter and/or glop onto the upper surface 70U. The material M also can engage and extend the inner diameter surface 80I, in particular the inner diameter surface trailing edge 80ITE. In doing so, the material M travels or spatters upward toward the upper surface 80U, with the inner diameter surface 80I acting as a backstop against which the material collides, due to the relative motion of the washer 80 in the direction of flow F, and the transverse direction of the material moving and/or falling along drop axis DA. This in turn, can form a slightly wedged or angled or curved structure with the liquid material M. Due to the surface adhesion of the material, it can also slightly creep or extend up the inner diameter surface 80I.

Optionally, as mentioned above, the washers 80 can have a small space 80S defined between the lower surface 80L and the upper surface 70U of the conveyor. Due to the liquid and/or flowable nature of the material M, certain amounts of the material can seep or otherwise enter into this space 80S. When the material M seeps between the lower surface 80L and the upper surface 70U of the washer, a seepage portion SP is formed, as described further below.

After the material M is applied to the moving washers, it is further conveyed along the conveyor 70 to the curing station 50, where the material can be cured optionally with irradiation. As mentioned above, the material optionally can be curable with UV/EB wavelength light. The material can be optionally acrylate, methacrylate, vinyl functional monomers and/or oligomers, optionally convertible from a liquid to solid and/or gel or semisolid state via application of certain wavelengths of light. As illustrated in FIGS. 1 and 2, the curing station 50 can include a first irradiator 51 and a second, subsequent irradiator 52. The first irradiator 51 can substantially cure the material M, forming a rigid, semisolid and/or solid yet resilient tab body B with the material M.

The irradiators can optionally project UV light from a 12 inch bulb onto an area of approximately 24 in² on the conveyor. The irradiator can project the light optionally for 1 second to about 10 seconds, further optionally about 5 seconds. Generally, the irradiators output light at greater than 300 W/inch², and further optionally greater than 400 W/inch² onto the washer and material. Utilizing a UV curable acrylic-based material can provide enhanced process speeds. The optional wavelength of light projected by the irradiators onto the washers can be optionally 200 nm to 600 nm, further optionally 150 nm to 450 nm, even further optionally 300 nm to 350 nm, and yet further optionally about 320 nm.

Optionally, the irradiators can be able to toggle between mercury, iron and/or gallium lamps to increase the spectrum range of the wavelengths exerted by the same. It is also to be noted that the irradiators can be positioned so that, relative to the washer, the irradiators are vertical and above the washer, generally projecting downward. This can provide full vertical adjustment of the irradiators, and also can enhance the full depth of cure of the liquid material when initially applied to the washers. The respective lamps also can be positioned inline along the linear conveyor as desired.

As noted above, the curing station 50 can include a second irradiator 52. While the first irradiator 51 fully cures most material, this second irradiator 52 can be included to ensure this is always the case, and to act as a backup in case the first irradiator fails.

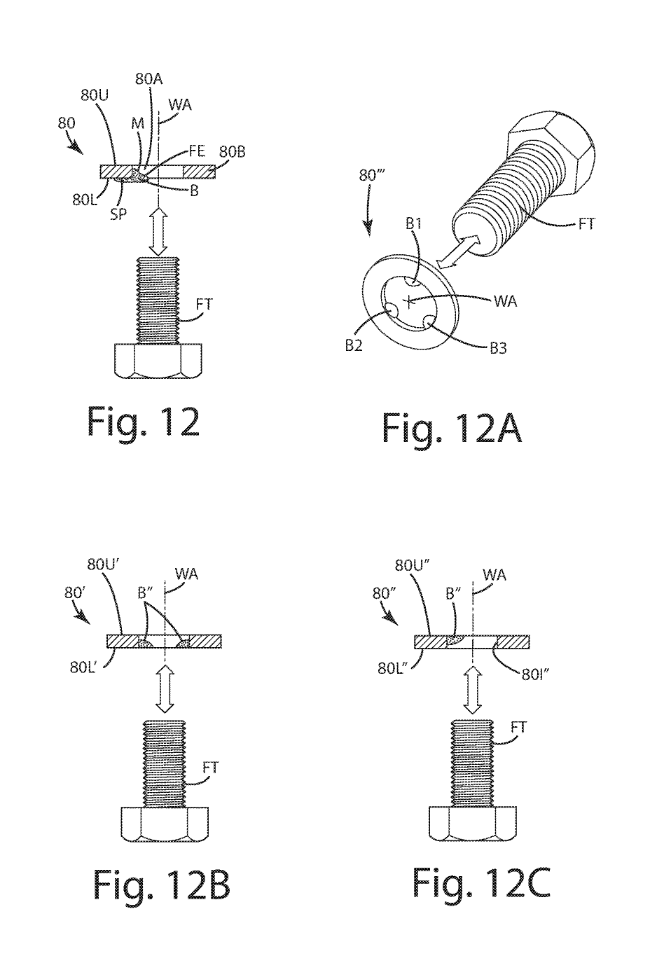

As shown in FIGS. 10-12, the retention aid body B can be secured or chemically and/or mechanically bonded to the washer 80. The retention aid body B is constructed from the curable material M dispensed by the dispensers in the dispensing station 30. It can be joined with the inner circumferential edge and/or inner diameter surface 80I of the washer body 80B. The retention aid body B can extend inward toward the aperture axis and/or washer axis WA a preselected distance, depending on the particular amount of engagement desired from the body with a fastener positioned through the washer aperture 80A. The retention aid body B can be generally resilient and can include a free end that is adapted to flex and engage a complementary part inserted through the aperture 80A. As discussed above, the resilient retention aid body B also can include a seepage portion SP that extends outwardly, beyond the inner circumferential edge and/or inner diameter surface 80I of the washer, generally toward the outer circumferential edge 80. The seepage portion SP can be joined and bonded with the lower surface 80L of the washer 80 as illustrated in FIGS. 11 and 12. The body B can be joined directly with the inner trailing edge 80ITE of the washer 80. Optionally, the body B can include a lower surface LS that extends toward the lower surface LSP of the seepage portion SP. These lower surfaces can be contiguous and planar, as they can be formed generally by the upper surface 70u of the conveyor, which is also planar. The seepage portion SP also can be configured so that it extends outward from the aperture 80A at or near the trailing edge 80ITE of the inner diameter surface, but does not extend outward at or near the leading edge 80ILE of the inner diameter surface.

As illustrated in FIGS. 10 and 11, the free end FE of the body B can be rounded, curved, nonlinear and/or irregular, when viewed from a top view of the washer as shown there. Indeed, the free end FE can include two or more curvatures contiguous with one another, and can be optionally non-linear, but rather curved along a majority of its length between separate contact points of that free end with the inner circumferential edge or trailing edge of the inner diameter. The free end can further include multiple different curvatures, optionally joined by a linear portion of the free end in some cases. The precise configuration of the free end FE as shown in the top view of FIG. 10 can be altered, depending on the manner in which the liquid retention material engages the washer inner diameter surface upon application. Further, as shown in a side section view of the washer in FIG. 12, the free end FE can be curved vertically, with a portion of the free end curving back away from the washer axis WA. Indeed, the free end and the upper surface of the body (facing away and upward from the lower surface 80L, optionally can be curved and non-linear, or in some cases linear if desired.

An attribute of the completed washers, particularly where acrylic based UV curable materials are used to form these retention aid bodies with the washer aperture, is the good to excellent adhesive properties of the retention aid bodies. This allows numerous reuses of the washer on complementary threaded fasteners inserted into the washer aperture, as well as other fasteners such as shoulder bolts, sheet metal screws, unthreaded pins and the like.

A first experiment was conducted on washers constructed according to the current embodiments having three retention aid bodies B1, B2 and B3 placed approximately 120 degrees from one another about a central axis WA of the washer 80′″, as shown in FIG. 12A. As seen in Table 1 below, bidirectional use was tested multiple times, with the fastener FT pushed into washer (“Push In” in Table 1), then pushed out (or pulled) (“Push Out” in Table 1) of the washer 80′. This illustrated that the current embodiments, even after five applications to threaded fasteners, still required at least 7.3 lbf to remove the fastener from the washer and vice versa. Optionally, even after five applications to threaded fasteners, the current embodiments of washers can utilize optionally at least 6 lbf, further optionally at least 7 lbf, even further optionally at least 8 lbf, and yet further optionally at least 10 lbf to remove the fastener from the washer and vice versa.

TABLE 1
Three Tab Retention Element Performance

| | 1^{st} Push | 1^{st} Push | 5^{th} Push |
|---|---|---|---|
| | In lbf | Out lbf | Out lbf |
| 1 | 5.2 | 13.6 | 9.4 |
| 2 | 5.0 | 12.7 | 7.1 |
| 3 | 7.7 | 19.1 | 7.4 |
| 4 | 4.5 | 12.3 | 6.8 |
| 5 | 5.2 | 14.5 | 5.3 |
| 6 | 4.8 | 12.4 | 5.6 |
| 7 | 8.1 | 18.7 | 9.3 |
| Average | 5.8 | 14.8 | 7.3 |

A second experiment was conducted on washers constructed according to the current embodiments having one retention aid body B about a central axis WA of the washer 80, as shown in FIGS. 10 and 12, with the body B being generally “down”, that is, located more on the lower part of the inner diameter surface 80I, closer to the lower surface 80L than toward the upper surface 80U (and with seepage portion SP absent) before the body B engages test fastener or bolt FT. Tabs in this position were indicated as “Orientation: Tab Down” in Table 2 below. The tab weight in grams for each Part or washer tested, and shot time for depositing the liquid material that forms the body was also recorded in the table. The fasteners FT used in this experiment were fully threaded bolts, size M10, and the washers were constructed primarily from zinc.

As seen in Table 2 below, bidirectional use was tested on multiple washers, also referred to as “Part X” in Table 2, six times for each of the six Parts, listed in the leftmost column of that table. In particular, each washer was assembled and pushed on the bolt FT. The maximum installation force in lbf to seat the washer in place against a head of the bolt was recorded as “In” in Table 2. After installation, each washer was pulled completely off the bolt FT. The maximum removal force in lbf to remove the washer from the bolt was recorded as “Out” in Table 2.

This experiment illustrated that the current embodiments of the washer, even after six applications to and five previous removals from threaded fastener FT, still required at least about 5 lbf to about 12 lbf to remove the washer from the fastener. Optionally, even after six applications and five removals from the threaded fasteners, the current embodiments of washers can utilize optionally at least 4.9 lbf, further optionally at least 6.5 lbf, even further optionally at least 11.5 lbf, and yet further optionally at least 11.7 lbf to remove the washers. In addition, the ratio of average values (the two leftmost columns) of installation (“In”) to removal (“Out”) forces was optionally less than 1:13 and further optionally less than about 2:8.

TABLE 2
One Tab, Tab Down, Retention Element Performance

| | | Size: M10 | | | | | | | | | | | | |
|---|---|---|---|---|---|---|---|---|---|---|---|---|---|---|
| | | Configuration: | | | | | | | | | | | | |
| | | 1 Tab | | | | Orientation: Tab Down | | | | | | | | |
| | | Shot Time: 0.17 s | | | | Tab Weight: ~0.036 g | | | | | | | | |
| | 1 | | 2 | | 3 | | 4 | | 5 | | 6 | | Ave | Ave |
| Part | In | Out | In | Out | In | Out | In | Out | In | Out | In | Out | In | Out |
| 1 | 2.3 | 13.4 | 0.8 | 6.6 | 1.8 | 6.9 | 2.4 | 7.7 | 1.9 | 16.0 | 0.8 | 11.5 | 1.7 | 10.4 |
| 2 | 4.7 | 4.7 | 1.4 | 5.9 | 1.7 | 5.1 | 2.3 | 10.4 | 2.4 | 12.6 | 1.5 | 6.5 | 2.3 | 7.5 |
| 3 | 1.7 | 5.7 | 0.9 | 28.4 | 1.7 | 11.3 | 2.0 | 13.0 | 1.7 | 11.4 | 0.9 | 4.9 | 1.5 | 12.5 |
| 4 | 2.5 | 9.6 | 2.6 | 3.3 | 6.3 | 5.2 | 4.2 | 6.6 | 2.3 | 25.8 | 1.9 | 5.0 | 3.3 | 9.3 |
| 5 | 1.9 | 8.3 | 1.4 | 6.6 | 2.0 | 4.7 | 4.6 | 9.9 | 2.6 | 17.3 | 1.7 | 11.7 | 2.4 | 9.8 |

A third experiment was conducted on washers constructed according to the current embodiments having two retention aid bodies B′ about a central axis WA of the washer 80′, as shown in FIG. 12B, with the bodies B′ being generally “down”, as described above. Tabs in this position were indicated as “Orientation: Tab Down” in Table 3 below. The tab weight in grams for each Part or washer tested, and shot time for depositing the liquid material that forms the body was also recorded in the table. The fasteners FT used in this experiment were fully threaded bolts, size M10, and the washers were constructed primarily from zinc.

As seen in Table 3 below, bidirectional use was tested on multiple washers or Parts as described in connection with the experiment represented in Table 2 above. The same measurements and indications, e.g., “In”, Out“, “Tab Down,” etc. in the experiment above apply to this experiment as well.

This experiment illustrated that the current embodiments of the washer, even after six applications to and five previous removals from threaded fastener FT, still required at least about 20 lbf to about 30 lbf to remove the washer from the fastener. Optionally, even after six applications and five removals from the threaded fasteners, the current embodiments of washers can utilize optionally at least 21.1 lbf, further optionally at least 23.2 lbf, even further optionally at least 25.1 lbf, and yet further optionally at least 27.2 lbf to remove the washers. In addition, the ratio of average values (the two leftmost columns) of installation (“In”) to removal (“Out”) forces was in some cases optionally less than 6:26 and further optionally less than about 8:19.

TABLE 3
Two Tabs, Tab Down, Retention Element Performance

| | | Size: M10 | | | | | | | | | | | | |
|---|---|---|---|---|---|---|---|---|---|---|---|---|---|---|
| | | Configuration: 2 | | | | | | | | | | | | |
| | | Tab | | | | Orientation: Tab Down | | | | | | | | |
| | | Shot Time: 0.10 s | | | | Tab Weight: ~0.021 g | | | | | | | | |
| | 1 | | 2 | | 3 | | 4 | | 5 | | 6 | | Ave | Ave |
| Part | In | Out | In | Out | In | Out | In | Out | In | Out | In | Out | In | Out |
| 1 | 6.4 | 42.2 | 7.4 | 35.7 | 4.2 | 16.4 | 4.5 | 15.2 | 5.7 | 23.4 | 6.6 | 27.2 | 5.8 | 26.7 |
| 2 | 9.4 | 26.1 | 8.4 | 28.5 | 2.5 | 15.5 | 4.4 | 18.1 | 6.1 | 15.9 | 5.5 | 25.1 | 6.1 | 21.5 |
| 3 | 16.3 | 17.9 | 6.7 | 26.3 | 2.5 | 13.5 | 3.9 | 15.4 | 6.2 | 28.5 | 7.6 | 23.2 | 7.2 | 20.8 |
| 4 | 17.9 | 21.5 | 6.5 | 27.1 | 4.8 | 13.8 | 4.6 | 17.3 | 5.9 | 14.9 | 6.0 | 21.1 | 7.6 | 19.3 |
| 5 | 10.6 | 20.0 | 5.5 | 17.9 | 3.4 | 11.7 | 3.2 | 12.6 | 2.6 | 13.7 | 5.5 | 23.3 | 5.1 | 16.5 |

A fourth experiment was conducted on washers constructed according to the current embodiments having three retention aid bodies B1, B2, B3 about a central axis WA of the washer 80′″, as shown in FIG. 12A, with the bodies being generally “down”, as described above. Tabs in this position were indicated as “Orientation: Tab Down” in Table 4 below. The tab weight in grams for each Part or washer tested, and shot time for depositing the liquid material that forms the body was also recorded in the table. The fasteners FT used in this experiment were fully threaded bolts, size M10, and the washers were constructed primarily from zinc.

As seen in Table 4 below, bidirectional use was tested on multiple washers or Parts as described in connection with the experiment represented in Table 2 above. The same measurements and indications, e.g., “In”, Out”, “Tab Down,” etc. in the experiment above apply to this experiment as well.

This experiment illustrated that the current embodiments of the washer, even after six applications to and removals from threaded fastener FT, still required at least about 20 lbf to about 30 lbf to remove the washer from the fastener. Optionally, even after six applications and five removals from the threaded fasteners, the current embodiments of washers can utilize optionally at least 21.5 lbf, further optionally at least 23.3 lbf, even further optionally at least 26.8 lbf, and yet further optionally at least 27.3 lbf to remove the washers. In addition, the ratio of average values (the two leftmost columns) of installation (“In”) to removal (“Out”) forces was in some cases optionally less than 7:28 and further optionally less than about 9:20.

TABLE 4
Three Tabs, Tab Down, Retention Element Performance

| | | Size: M10 | | | | | | | | | | | | |
|---|---|---|---|---|---|---|---|---|---|---|---|---|---|---|
| | | Configuration: 3 Tab | | | | Orientation: Tab Down | | | | | | | | |
| | | Shot Time: 0.10 s | | | | Tab Weight: ~0.021 g | | | | | | | | |
| | 1 | | 2 | | 3 | | 4 | | 5 | | 6 | | Ave | Ave |
| Part | In | Out | In | Out | In | Out | In | Out | In | Out | In | Out | In | Out |
| 1 | 4.8 | 25.0 | 10.0 | 37.3 | 8.0 | 27.3 | 2.1 | 21.9 | 8.1 | 31.3 | 5.8 | 26.9 | 6.5 | 28.3 |
| 2 | 5.0 | 28.3 | 10.0 | 43.3 | 10.4 | 27.1 | 4.8 | 15.2 | 15.4 | 31.9 | 5.5 | 27.3 | 8.5 | 28.9 |
| 3 | 4.0 | 20.1 | 11.7 | 33.9 | 6.6 | 28.1 | 3.7 | 12.5 | 7.8 | 29.8 | 6.1 | 21.5 | 6.7 | 24.3 |
| 4 | 13.2 | 17.3 | 8.4 | 31.6 | 10.7 | 18.5 | 2.2 | 13.1 | 6.8 | 24.8 | 11.9 | 26.8 | 8.9 | 22.0 |
| 5 | 8.6 | 10.5 | 21.7 | 21.7 | 10.0 | 24.7 | 2.8 | 14.1 | 6.3 | 21.9 | 7.8 | 23.3 | 9.5 | 19.4 |

A fifth experiment was conducted on washers constructed according to the current embodiments having one retention aid body B about a central axis WA of the washer 80″, as shown in FIG. 12C, with the body B″ being generally “up”, that is, located more on the upper part of the inner diameter surface 80I″, closer to the upper surface 80U″ than toward the lower surface 80L″ (and with seepage portion SP absent) before the body B″ engages test fastener or bolt FT. Tabs in this position were indicated as “Orientation: Tab Up” in Table 5 below. The tab weight in grams for each Part or washer tested, and shot time for depositing the liquid material that forms the body was also recorded in the table. The fasteners FT used in this experiment were fully threaded bolts, size M10, and the washers were constructed primarily from zinc.

As seen in Table 5 below, bidirectional use was tested on multiple washers, also referred to as “Part X” in Table 5, six times for each of the six Parts, listed in the leftmost column of that table. In particular, each washer was assembled and pushed on the bolt FT. The maximum installation force in lbf to seat the washer in place against a head of the bolt was recorded as “In” in Table 5. After installation, each washer was pulled completely off the bolt FT. The maximum removal force in lbf to remove the washer from the bolt was recorded as “Out” in Table 5.

This experiment illustrated that the current embodiments of the washer, even after six applications to and removals from threaded fastener FT, still required at least about 1 lbf to about 3 lbf to remove the washer from the fastener. Optionally, even after six applications and five removals from the threaded fasteners, the current embodiments of washers can utilize optionally at least 1.1 lbf, further optionally at least 1.7 lbf, even further optionally at least 2.1 lbf, and yet further optionally at least 2.6 lbf to remove the washers.

TABLE 5
One Tab, Tab Up, Retention Element Performance

| | | Size: M10 | | | | | | | | | | |
|---|---|---|---|---|---|---|---|---|---|---|---|---|
| | | Configuration: 1 | | | | | | | | | | |
| | | Tab | | | | Orientation: Tab Up | | | | | | |
| | | Shot Time: 0.17 s | | | | Tab Weight: ~0.036 g | | | | | | |
| | 1 | | 2 | | 3 | | 4 | | 5 | | Ave | Ave |
| Part | In | Out | In | Out | In | Out | In | Out | In | Out | In | Out |
| 1 | 5.2 | 8.1 | 4.7 | 6.4 | 9.9 | 6.3 | 6.0 | 6.3 | 0.9 | 1.5 | 5.3 | 5.7 |
| 2 | 4.6 | 2.7 | 8.9 | 5.0 | 5.8 | 6.2 | 3.1 | 7.7 | 0.6 | 2.1 | 4.6 | 4.7 |
| 3 | 3.0 | 3.8 | 9.9 | 3.9 | 6.5 | 7.5 | 6.2 | 9.5 | 0.9 | 1.7 | 5.3 | 5.3 |
| 4 | 2.7 | 6.6 | 3.9 | 4.2 | 4.5 | 7.0 | 6.4 | 3.4 | 0.8 | 2.6 | 3.7 | 4.8 |
| 5 | 6.0 | 6.6 | 4.4 | 3.1 | 4.7 | 10.4 | 7.8 | 4.9 | 1.5 | 1.1 | 4.9 | 5.2 |

A sixth experiment was conducted on washers constructed according to the current embodiments having two retention aid bodies B″ about a central axis WA of the washer 80′, as shown in FIG. 12B, but with the bodies B′ being generally “up”, like the body or tab B″ shown in FIG. 12C, as described above. Tabs in this position were indicated as “Orientation: Tab Up” in Table 6 below. The tab weight in grams for each Part or washer tested, and shot time for depositing the liquid material that forms the body was also recorded in the table. The fasteners FT used in this experiment were fully threaded bolts, size M10, and the washers were constructed primarily from zinc.

As seen in Table 6 below, bidirectional use was tested on multiple washers or Parts as described in connection with the experiment represented in Table 5 above. The same measurements and indications, e.g., “In”, Out”, “Tab Up” etc. in the experiment above apply to this experiment as well.

This experiment illustrated that the current embodiments of the washer, even after six applications to and five previous removals from threaded fastener FT, still required at least about 6 lbf to about 12 lbf to remove the washer from the fastener. Optionally, even after six applications and five removals from the threaded fasteners, the current embodiments of washers can utilize optionally at least 7.4 lbf, further optionally at least 10.9 lbf, and even further optionally at least 15.1 lbf, to remove the washers.

TABLE 6
Two Tabs, Tab Up, Retention Element Performance

| | | Size: M10 | | | | | | | | | | |
|---|---|---|---|---|---|---|---|---|---|---|---|---|
| | | Configuration: 2 Tab* | | | | Orientation: Tab Up | | | | | | |
| | | Shot Time: 0.10 s | | | | Tab Weight: ~0.021 g | | | | | | |
| | 1 | | 2 | | 3 | | 4 | | 5 | | Ave | Ave |
| Part | In | Out | In | Out | In | Out | In | Out | In | Out | In | Out |
| 1 | 14.9 | 10.3 | 16.7 | 16.9 | 16.4 | 14.5 | 14.0 | 15.2 | 13.7 | 12.2 | 15.1 | 13.8 |
| 2 | 10.0 | 8.6 | 14.9 | 15.9 | 9.0 | 14.8 | 12.6 | 14.3 | 8.0 | 8.9 | 10.9 | 12.5 |
| 3 | 9.6 | 10.7 | 8.1 | 14.7 | 6.6 | 10.4 | 7.3 | 11.2 | 5.5 | 6.6 | 7.4 | 10.7 |
| 4 | 1.9 | 9.4 | 9.6 | 12.9 | 10.3 | 10.5 | 5.4 | 12.0 | 4.8 | 8.2 | 6.4 | 10.6 |
| 5 | 7.2 | 10.1 | 8.9 | 13.8 | 4.9 | 7.9 | 4.6 | 11.9 | 11.0 | 6.7 | 7.3 | 10.1 |

*Note:
Some parts had partial delamination of 1 tab after 3-5 uses.

A seventh experiment was conducted on washers constructed according to the current embodiments having three retention aid bodies B1, B2, B3 about a central axis WA of the washer 80′″, as shown in FIG. 12A, but with the bodies being generally “up”, like that shown in FIG. 12C, as described above. Tabs in this position were indicated as “Orientation: Tab Up” in Table 7 below. The tab weight in grams for each Part or washer tested, and shot time for depositing the liquid material that forms the body was also recorded in the table. The fasteners FT used in this experiment were fully threaded bolts, size M10, and the washers were constructed primarily from zinc.

As seen in Table 7 below, bidirectional use was tested on multiple washers or Parts as described in connection with the experiment represented in Table 5 above. The same measurements and indications, e.g., “In”, Out”, “Tab Up” etc. in the experiment above apply to this experiment as well.

This experiment illustrated that the current embodiments of the washer, even after six applications to and five previous removals from threaded fastener FT, still required at least about 10 lbf to about 17 lbf to remove the washer from the fastener. Optionally, even after six applications and five removals from the threaded fasteners, the current embodiments of washers can utilize optionally at least 14.6 lbf, further optionally at least 18.5 lbf, and even further optionally at least 22.8 lbf, to remove the washers.

TABLE 7
Three Tabs, Tab Up, Retention Element Performance

| | | Size: M10 | | | | | | | | | | |
|---|---|---|---|---|---|---|---|---|---|---|---|---|
| | | Configuration: 3 Tab* | | | | Orientation: Tab Up | | | | | | |
| | | Shot Time: 0.10 s | | | | Tab Weight: ~0.021 g | | | | | | |
| | 1 | | 2 | | 3 | | 4 | | 5 | | Ave | Ave |
| Part | In | Out | In | Out | In | Out | In | Out | In | Out | In | Out |
| 1 | 22.4 | 21.6 | 25.2 | 31.1 | 25.0 | 34.0 | 20.1 | 24.9 | 21.5 | 17.3 | 22.8 | 25.8 |
| 2 | 15.2 | 17.5 | 22.6 | 23.8 | 21.6 | 27.7 | 16.3 | 19.4 | 17.0 | 15.9 | 18.5 | 20.9 |
| 3 | 11.7 | 14.5 | 19.9 | 25.5 | 19.5 | 25.2 | 11.4 | 17.1 | 10.5 | 14.9 | 14.6 | 19.4 |
| 4 | 9.9 | 11.7 | 13.5 | 23.1 | 13.3 | 22.1 | 9.9 | 14.1 | 14.0 | 13.3 | 12.1 | 16.9 |
| 5 | 4.5 | 21.1 | 10.9 | 24.1 | 13.1 | 21.0 | 13.3 | 15.0 | 7.2 | 10.3 | 9.8 | 18.3 |

*Note:
Some parts had delamination of 1 tab after 3-5 uses.

Eight through thirteenth experiments were conducted on washers constructed according to the current embodiments having one, two or three retention bodies or tabs, with tabs up or down, similar to those experiments above, and as indicated in Tables 8-13 below. The tab weight in grams for each Part or washer tested, and shot time for depositing the liquid material that forms the bodies was also recorded in the respective tables. The fasteners FT used in this experiment were fully threaded bolts, size ⅜ inch, and the washers were constructed primarily from zinc.

TABLE 8
One Tab, Tab Down, Retention Element Performance

| | | Size: ⅜ths | | | | | | | | | | |
|---|---|---|---|---|---|---|---|---|---|---|---|---|
| | | Configuration: 1 | | | | | | | | | | |
| | | Tab | | | | Orientation: Tab Down | | | | | | |
| | | Shot Time: 0.17 s | | | | Tab Weight: ~0.036 g | | | | | | |
| | 1 | | 2 | | 3 | | 4 | | 5 | | Ave | Ave |
| Part | In | Out | In | Out | In | Out | In | Out | In | Out | In | Out |
| 1 | 1.2 | 11.1 | 5.2 | 4.6 | 2.7 | 3.7 | 3.3 | 6.8 | 5.2 | 4.6 | 3.5 | 6.2 |
| 2 | 1.1 | 7.3 | 4.6 | 3.7 | 2.9 | 6.9 | 1.0 | 7.6 | 3.1 | 5.5 | 2.5 | 6.2 |
| 3 | 2.7 | 7.2 | 2.4 | 3.9 | 2.5 | 6.7 | 2.0 | 6.3 | 2.7 | 6.2 | 2.5 | 6.1 |
| 4 | 2.0 | 5.3 | 2.6 | 3.3 | 2.0 | 12.7 | 0.8 | 4.3 | 2.9 | 4.8 | 2.1 | 6.1 |
| 5 | 1.8 | 7.9 | 1.8 | 6.8 | 0.8 | 12.9 | 1.6 | 3.3 | 2.5 | 7.5 | 1.7 | 7.7 |

TABLE 9
Two Tabs, Tab Down, Retention Element Performance

| | | Size: ⅜ths | | | | | | | | | | |
|---|---|---|---|---|---|---|---|---|---|---|---|---|
| | | Configuration: 2 Tab* | | | | Orientation: Tab Down | | | | | | |
| | | Shot Time: 0.17 s | | | | Tab Weight: ~0.036 g | | | | | | |
| | 1 | | 2 | | 3 | | 4 | | 5 | | Ave | Ave |
| Part | In | Out | In | Out | In | Out | In | Out | In | Out | In | Out |
| 1 | 5.5 | 13.7 | 4.2 | 12.3 | 3.8 | 12.2 | 4.2 | 12.8 | 3.1 | 12.0 | 4.2 | 12.6 |
| 2 | 4.0 | 12.1 | 4.8 | 9.9 | 3.7 | 9.9 | 4.0 | 12.8 | 2.7 | 10.9 | 3.8 | 11.1 |
| 3 | 3.9 | 12.7 | 4.1 | 10.6 | 5.3 | 11.8 | 3.4 | 12.5 | 3.1 | 8.1 | 4.0 | 11.1 |
| 4 | 4.0 | 8.9 | 3.9 | 11.4 | 4.1 | 10.1 | 3.9 | 12.1 | 2.5 | 5.9 | 3.7 | 9.7 |
| 5 | 3.3 | 9.7 | 4.0 | 9.0 | 4.6 | 9.5 | 2.4 | 7.5 | 3.2 | 8.1 | 3.5 | 8.8 |

*Note
Partial delamination of 1 tab after 3-4 uses.

TABLE 10
Three Tabs, Tab Down, Retention Element Performance

| | | Size: ⅜^{ths} | | | | | | | | | | |
|---|---|---|---|---|---|---|---|---|---|---|---|---|
| | | Configuration: 3 Tab | | | | Orientation: Tab Down | | | | | | |
| | | Shot Time: 0.08 s | | | | Tab Weight: ~0.025 g | | | | | | |
| | 1 | | 2 | | 3 | | 4 | | 5 | | Ave | Ave |
| Part | In | Out | In | Out | In | Out | In | Out | In | Out | In | Out |
| 1 | 4.2 | 13.6 | 3.9 | 14.5 | 3.0 | 8.9 | 4.7 | 14.7 | 3.3 | 10.0 | 3.8 | 12.3 |
| 2 | 4.5 | 13.1 | 4.4 | 10.8 | 2.9 | 8.2 | 4.9 | 15.2 | 2.5 | 8.0 | 3.8 | 11.1 |
| 3 | 5.9 | 10.9 | 5.5 | 11.0 | 3.2 | 7.9 | 4.2 | 12.8 | 2.3 | 9.7 | 4.2 | 10.5 |
| 4 | 4.1 | 11.4 | 4.3 | 13.4 | 4.9 | 6.8 | 5.1 | 16.0 | 6.0 | 10.1 | 4.9 | 11.5 |
| 5 | 5.8 | 12.9 | 6.3 | 13.6 | 2.7 | 7.4 | 5.1 | 13.2 | 4.0 | 10.6 | 4.8 | 11.5 |

TABLE 11
One Tab, Tab Up, Retention Element Performance

| | | Size: ⅜ths | | | | | | | | | | |
|---|---|---|---|---|---|---|---|---|---|---|---|---|
| | | Configuration: 1 | | | | | | | | | | |
| | | Tab | | | | Orientation: Tab Up | | | | | | |
| | | Shot Time: 0.17 s | | | | Tab Weight: ~0.036 g | | | | | | |
| | 1 | | 2 | | 3 | | 4 | | 5 | | Ave | Ave |
| Part | In | Out | In | Out | In | Out | In | Out | In | Out | In | Out |
| 1 | 4.4 | 6.0 | 3.4 | 6.9 | 11.4 | 5.7 | 6.1 | 6.7 | 6.4 | 6.6 | 6.3 | 6.4 |
| 2 | 4.8 | 10.5 | 3.7 | 3.8 | 4.0 | 8.4 | 6.8 | 7.7 | 2.7 | 3.3 | 4.4 | 6.7 |
| 3 | 4.1 | 8.3 | 4.6 | 6.5 | 9.3 | 6.4 | 3.5 | 7.1 | 4.9 | 4.1 | 5.3 | 6.5 |
| 4 | 5.3 | 4.7 | 5.7 | 6.5 | 9.5 | 9.9 | 5.0 | 5.4 | 2.2 | 6.8 | 5.5 | 6.7 |
| 5 | 4.7 | 6.2 | 6.0 | 6.5 | 8.9 | 6.8 | 9.7 | 4.9 | 2.7 | 3.8 | 6.4 | 5.6 |

TABLE 12
Two Tabs, Tab Up, Retention Element Performance

| | | Size: ⅜ths | | | | | | | | | | |
|---|---|---|---|---|---|---|---|---|---|---|---|---|
| | | Configuration: 2 Tab* | | | | Orientation: Tab Up | | | | | | |
| | | Shot Time: 0.17 s | | | | Orientation: Tab Up | | | | | | |
| | 1 | | 2 | | 3 | | 4 | | 5 | | Ave | Ave |
| Part | In | Out | In | Out | In | Out | In | Out | In | Out | In | Out |
| 1 | 7.6 | 13.7 | 11.0 | 15.8 | 9.0 | 14.4 | 9.3 | 13.2 | 14.5 | 17.1 | 10.3 | 14.8 |
| 2 | 9.0 | 10.9 | 8.5 | 9.0 | 11.1 | 15.8 | 9.7 | 9.6 | 5.4 | 10.1 | 8.7 | 11.1 |
| 3 | 7.4 | 11.8 | 9.1 | 9.9 | 8.3 | 10.7 | 7.2 | 11.9 | 9.9 | 6.5 | 8.4 | 10.2 |
| 4 | 5.7 | 7.4 | 6.5 | 6.8 | 5.4 | 10.7 | 6.2 | 11.1 | 6.1 | 7.8 | 6.0 | 8.8 |
| 5 | 3.1 | 6.9 | 5.0 | 5.4 | 6.0 | 2.5 | 6.9 | 14.1 | 3.2 | 6.0 | 4.8 | 7.0 |

*Note:
Partial delamination of 1 tab after 3-4 uses.

TABLE 13
Three Tabs, Tab Up, Retention Element Performance

| | | Size: ⅜^{ths} | | | | | | | | | | |
|---|---|---|---|---|---|---|---|---|---|---|---|---|
| | | Configuration: 3 Tab | | | | Orientation: Tab Up | | | | | | |
| | | Shot Time: 0.08 s | | | | Tab Weight: ~0.025 g | | | | | | |
| | 1 | | 2 | | 3 | | 4 | | 5 | | Ave | Ave |
| Part | In | Out | In | Out | In | Out | In | Out | In | Out | In | Out |
| 1 | 10.3 | 11.2 | 13.0 | 18.7 | 12.3 | 14.7 | 15.0 | 18.4 | 17.1 | 21.3 | 13.5 | 16.9 |
| 2 | 8.7 | 9.6 | 11.1 | 10.9 | 11.4 | 13.8 | 15.0 | 15.7 | 14.8 | 20.9 | 12.2 | 14.2 |
| 3 | 10.2 | 7.8 | 10.5 | 9.8 | 10.0 | 10.1 | 9.5 | 18.6 | 13.4 | 13.4 | 10.7 | 11.9 |
| 4 | 8.6 | 8.8 | 8.8 | 6.4 | 9.0 | 10.2 | 7.3 | 11.9 | 10.2 | 13.9 | 8.8 | 10.2 |
| 5 | 7.5 | 9.2 | 8.9 | 10.9 | 14.6 | 10.1 | 8.8 | 5.7 | 11.4 | 12.0 | 10.2 | 9.6 |

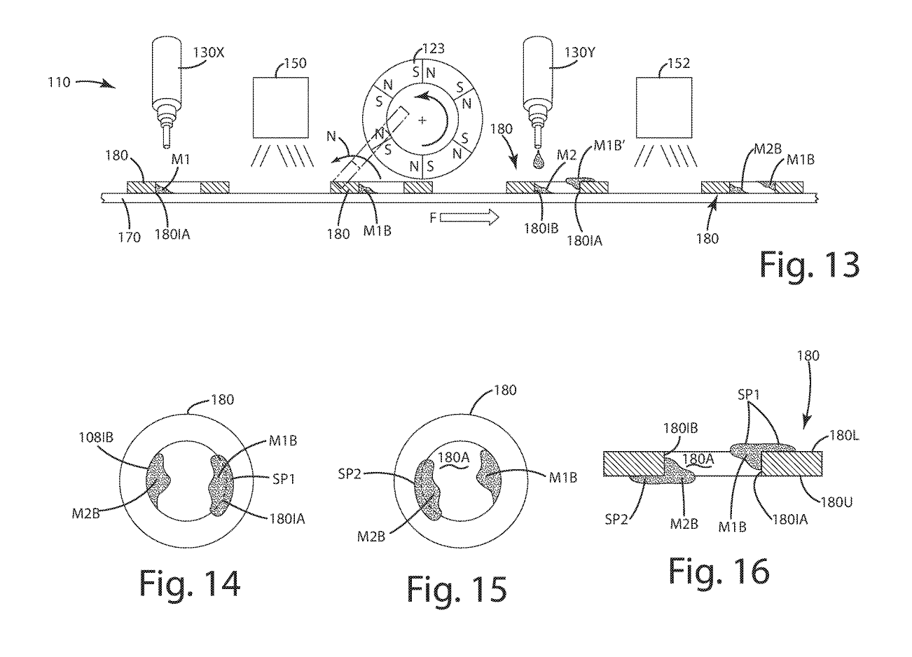

A first alternative embodiment of the apparatus and related method is illustrated in FIGS. 13-16 and generally designated 110. This embodiment can be similar in structure, function and operation to the embodiment described above with several exceptions. For example, this embodiment can include a conveyor 170 that linearly and horizontally conveys washers 180 along a substantially horizontal path in a direction of flow F. In this embodiment, the apparatus 110 can include a first dispenser 130 and a second dispenser 130Y, spaced from one another a distance along the conveyor 170. The first dispenser 130 dispenses a first liquid retention aid material M1, which engages a first inner diameter surface 180IA of the washer 180. This retention aid material M1 can be cured with a first irradiator 150, which can be similar to the irradiators in the curing station 50 above.

After the material M1 on the inner edge portion 180IA is cured, a magnetic wheel 123 or other flipping mechanism can be utilized to pick up and flip the washer 180 end over end in a direction N so that the cured retention tab body M1B is flipped 180° and basically upside down. With the flipped positioning of tab body M1B, that body, as flipped, is referred to as M1B′. The washer 180 then passes the second dispenser 130Y, which dispenses a second amount of liquid retention aid material M2, which is forcefully projected along and/or falls downward and engages an opposing or second portion 80IB of the inner diameter surface, which can be diametrically opposed to the first surface 180IA where the body M1B′ is joined. This second amount of material M2 joins with and is bonded to the inner diameter surface to form a second retention aid projection M2B. Subsequently, the washer 180 moves in the direction of flow F, and is cured at a second curing station 152. The resulting cured washer can include a first retention aid projection M1B and a second opposing retention aid projection M2B, generally facing first toward or projecting toward one another. Additional retention aid projections can be added by duplicating the elements illustrated in FIG. 13, and rotating the washer about its axis, then applying material again in a new location. Further, it will be appreciated that different types of mechanisms can be used to flip and/or rotate the washers in any desired configuration.

FIGS. 14-16 better illustrate the washer 180 with the multiple retention aid projections. There, the washer includes opposing retention aid bodies M1B and M2B. These bodies are joined with the respective portions of the inner diameter surface, namely, 180IA and 180IB. Each of the respective bodies also can include seepage portions. For example, body M1B can include a seepage portion SP1. The second body M2B can include a second seepage portion SP2. The respective seepage portions can be disposed on opposing upper and lower surfaces. For example, seepage portion SP1 can be disposed on the “lower” surface 180L, while the seepage portion SP2 can be disposed on the “upper” surface 180U.

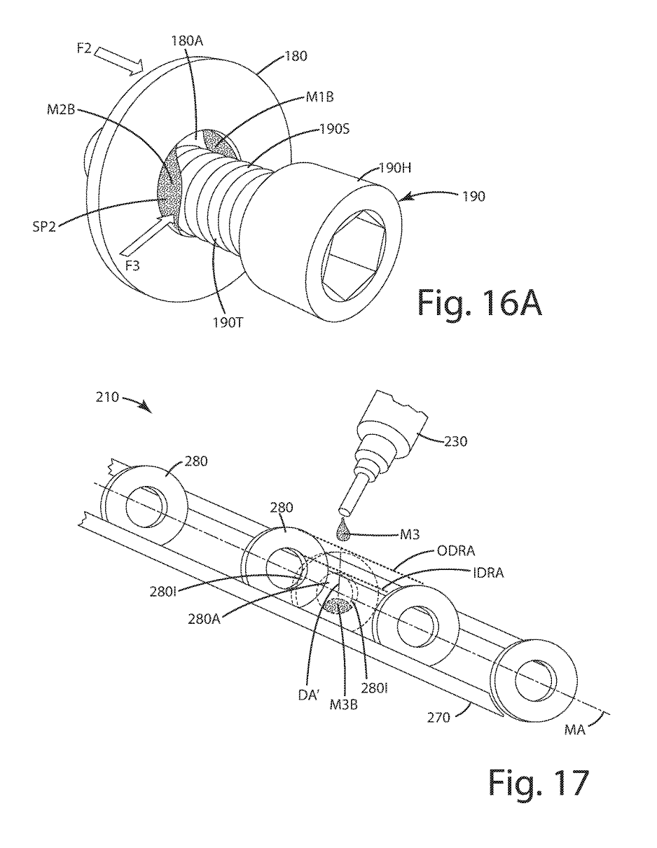

As shown in FIG. 16A, the washer 180 can be installed on an elongated faster 190. The fastener can include a head 190H and a shaft 190S extending from it. Multiple threads 190T can be disposed along a shaft 190S. The washer 180 can be pushed with a push on force F2 onto the shaft 190S either automatically or manually. As the washer is pushed on with this force, the bodies M1B and M2B flex and/or bend, being partially deflected by the threads 190 T and/or the shaft 190S. Because the retention aid bodies are flexible yet somewhat semi-rigid, they exert a holding force F3 on the threads and/or shaft of the fastener. In this manner, the retention aid bodies can serve to hold and secure the washer 180 on the faster shaft 190S.

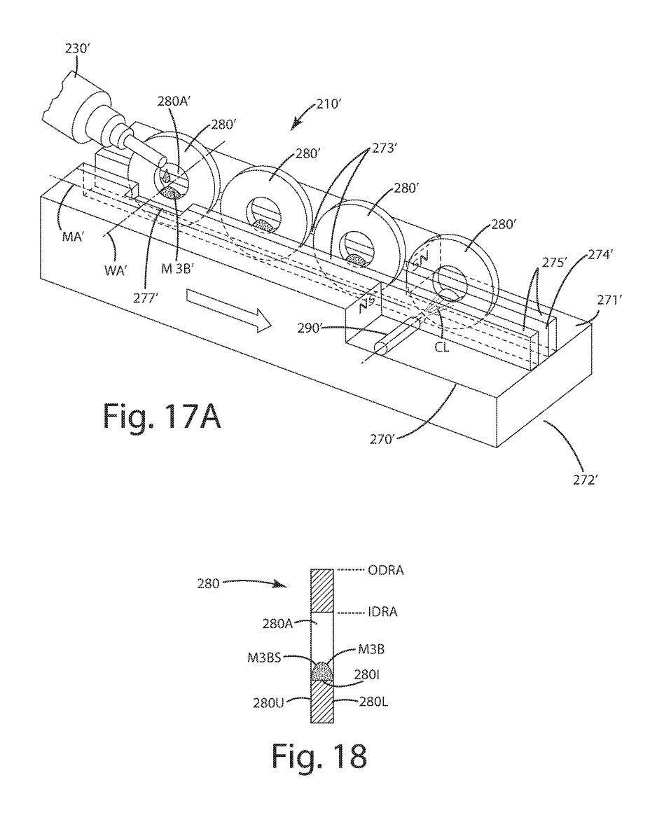

A second alternative embodiment of the apparatus and method is illustrated in FIG. 17 and generally designated 210. This embodiment is similar to the embodiments above in structure, function and operation, with several exceptions. For example, this embodiment includes a conveyor system 270 that is configured to convey washers 280 generally in a vertical configuration along a machine axis MA, which passes through the center of each of the washers 280. The outer circumferential edges of each respective washer can be supported by the conveyor 270, for example, magnetically, and moved along the movement axis MA. As the washers pass a dispenser 230 of a dispensing station, an amount of material M3 can be dispensed therefrom. This material M3 drops along a drop axis DA′, eventually landing on a portion of the inner diameter surface 280I.

Due to the vertical orientation of the washers, as the amount of material M3 drops, the droplet passes through or by an outer diameter reference axis ODRA and passes through or by an inner diameter reference axis IDRA as the material M3 is forcefully projected and/or falls along the drop axis DA′. Thus, the material M3 perfectly moves into an area of the aperture 280A of the washer 280 as the washer moves along the movement axis. This enables the liquid retention aid material M3 to continue to move and/or fall and to be deposited on the inner diameter surface 280I, generally between the upper and lower surfaces 280U and 280L of the washer 280. This is better illustrated in FIG. 18. There, the material is cured to form a retention aid body, using similar techniques as these in the embodiments above. This body M3B can extend generally between the upper surface or left surface 280U and the right surface or lower surface to 280L of the washer 280. The inwardly facing surface M3BS of the body M3B however, forms a rounded, parabolic and/or half-circular cross section as shown in FIG. 18. Although not shown, slight amounts of the body can form seepage portions along one or both of the surfaces 280U and to 280L.

A variation of the second alternative embodiment of the apparatus and method is illustrated in FIG. 17A and generally designated 210′. This embodiment is similar to the second alternative embodiment above in structure, function and operation, with several exceptions. For example, this embodiment includes a conveyor system 270′ that is configured to convey washers 280′ generally in a vertical configuration along a machine axis MA′, which is generally transverse to the washer axes WA′ of each of the washers as those washers travel along the conveyor system 270′. Optionally, each of the washer axes WA′ can be perpendicular to the machine axis MA′, which is generally the axis along which the washers 280′ are conveyed. These washers can be held in an upright or vertical orientation as illustrated, moving along the conveyor in an outer diameter to outer diameter configuration, rather than a lower surface to upper surface washer configuration of the second alternative embodiment in FIG. 17. The outer circumferential edges of each respective washer can be supported by the conveyor system 270′, for example, magnetically, and moved along the movement axis MA′.

As illustrated in FIG. 17A, the conveyor system 270′ can include a slot 274′ that is bounded by guides 273′ and optional magnets 271′ and 272′. The magnets can be oriented across the slot with the same poles facing one another in a NS-SN configuration as shown, or alternatively in a SN-NS configuration. These magnets adjacent the guides and the slot can assist in holding the washers in the upright, generally vertical orientation as shown. Optionally, the guides can be stainless steel, a composite, a polymer or some other non-magnetic material. Further optionally, the guides 273′ can include surface treatments having low friction and low adherence properties to enhance movement of the washers along movement axis MA′, and to prevent the material from the body M3B′ from adhering to the surfaces of the slot. As the washers 280′ move along the slot, optionally they can roll, or they can be maintained in the position as shown in FIG. 17A by the magnets, without rolling.

The apparatus 210′ also can include a dispenser gun 230′. The dispenser gun 230′ can be offset laterally from the movement axis MA′. The gun 230′ can be aligned so that it projects material for deposition as a material body M3B′ on the inner diameter of the washer 280′. The material can be shot into the aperture 280A′ laterally from the gun 230′ toward the movement axis MA′. The conveyor system can include a recess or window 277′ adjacent the slot 274′ so that the gun can have open access to the aperture of the washer for deposition of the material on the inner diameter of the washer.

Optionally, the slot 274′ can be configured to include a portion having secondary guides 275′ downstream of the gun 230′. These guides can be constructed from transparent and/or translucent material, such as polycarbonate, borosilicate glass and other similar materials. The construction of the guides 275′ can enable a light source, such as a UV curing light source 290′, to project UV light CL, or light of some other wavelength, onto the material body MB3′ to cure it as the washers travel along the conveyor system in the slot.

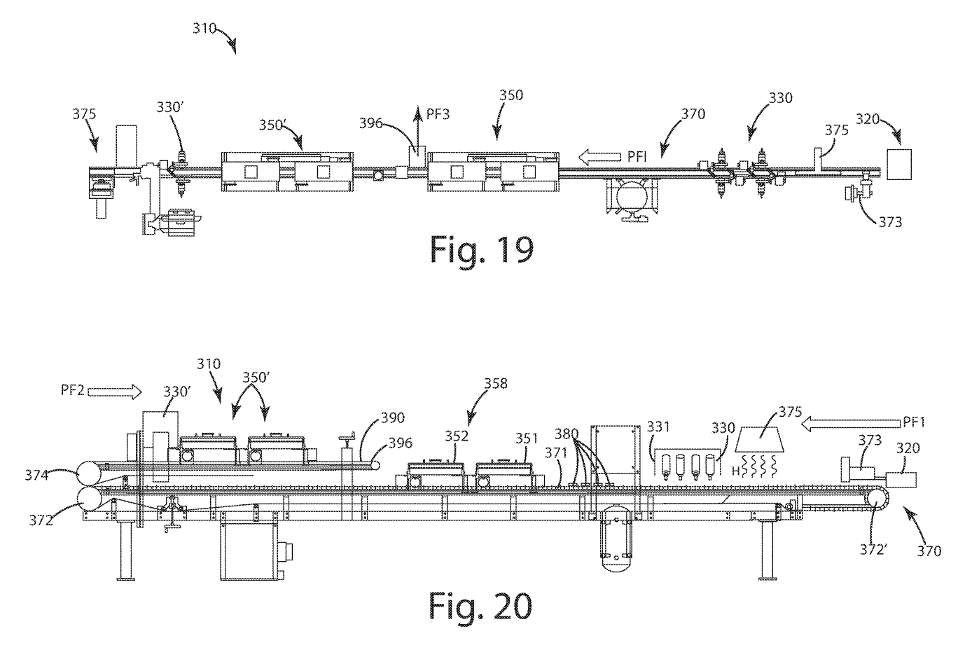

A third alternative embodiment of the apparatus and related method is illustrated in FIGS. 19-21 and generally designated 310. This embodiment can be similar in structure, function and operation to the embodiments described above with several exceptions. For example, this embodiment can include a first conveyor 370 that linearly and horizontally conveys washers 380 along a substantially horizontal path in a first direction of flow PF1, and a second conveyor 390 that linearly and horizontally conveys washers 380 along a substantially horizontal path in a second direction of flow PF2. The upper and lower surfaces of the washers can likewise travel in the respective horizontal paths. In this embodiment, the apparatus 310 can be set up to apply a type of retention aid material, for example, a hot melt adhesive, a polyamide, a polyolefin and/or PUR hot melt (all generally referred to herein as hot melt material), in liquid form, or some other liquid retention aid material to the washers 380, at more than one location around an inner diameter of the washers 380.

As an example, the apparatus 310 can construct washers similar to those shown in FIGS. 14-16 in the embodiment above. To do so, the apparatus can include a system of conveyors, optionally disposed one over the other. Of course, in other embodiments conveyors can be side-by-side and/or at angles relative to one another from a top view. The conveyors can be set up so that the washers 380 can be conveyed along the first conveyor 370 along a first product flow PF1, flipped over at the transfer station 375, and then conveyed along the second conveyor 390 along a second product flow PF2, that is the opposite direction relative to the first product flow PF1. Of course, in other constructions, the directions of the product flows can be at angles relative to one another. For example, the product flows can be perpendicular to one another and/or in the same direction relative to one another, depending on the transfer stations capabilities.

Optionally, the first conveyor 370 can include a belt 371 that is routed around a first roller or drum 372 and a second roller 372′. The roller 372 can be a drive roller or it can be a free rolling roller. The roller 372 can rotate in direction A1 so that the belt 371 can convey product in the direction of product flow PF1. The first conveyor 370 can be similar to the conveyors noted above in other embodiments with several exceptions. For example, the first conveyor 370 can be placed adjacent a feeding station 320, which can be a vibratory bowl feeder or other feeder as described herein. The feeder 320 can feed apertured parts 380, such as washers, onto the conveyor belt 371. The conveyor belt 371 can include a magnetic bed and a release agent incorporated into an upper surface of the belt, similar to that described in the embodiments above. This conveyor also can include a feed wheel 373, similar to the feed wheel noted in the embodiments above, that meters and/or spaces washers at a consistent and/or preselected distance from one another as they travel on or are conveyed along the conveyor belt 371.

The apparatus 310 can include a preheat station 375, on the first conveyor 370. The preheat station 375 can include a heat source. The heat source can be an induction type heat source, an irradiation-based heat source, or any other type of heating element. The preheat station 375 can exert heat H on the washers 380 disposed on the conveyor after the feeding station 320, but before the dispensing station 330. The heating station 375 can exert enough heat so that the washers are brought to a temperature of optionally about 100° F. to about 500° F., further optionally 150° F. to about 400° F. before they reach the dispensing station 330. With this preheating of the washers, the hot melt materials can bond more easily and quickly to the surfaces of the washers 380. Of course, with certain hot melt materials, the heating station 375 can be eliminated or substituted with a simpler device that does not heat the washers conveyed thereon too significantly.

After the washers 380 are preheated at the heating station 375, they are conveyed along the conveyor 371 toward the dispensing station 330. The dispensing station 330 can include a tank or other source of hot melt material, and one or more dispensing gun modules that are configured to dispense the hot melt material, optionally in a heated liquid form therefrom. As with the embodiments above, shown in FIGS. 7-9 for example, the dispensing guns can be configured to shoot and/or dispense the hot melt material toward the washer apertures and the belt along a predefined trajectory, so that the washers have associated there with retention aid bodies similar to the those shown in the embodiments of FIGS. 10-12. This can be achieved using compressed air to expel the hot melt material out of the dispensing gun module. Other mechanical dispensing mechanisms can be substituted for the compressed air system to perform the same function of shooting the hot melt material toward the washers and/or conveyor. Optionally, the dispensing gun module can eject the hot melt material so that it falls under the force of gravity toward the belt and aperture of the washer.

The dispensing station 330 can be set up so that the dispensing gun modules dispense the hot melt material at particular viscosities. For example, the viscosity of the hot melt material when ejected from the dispensing gun module can be a viscosity of optionally 5000 cps to 40,000 cps, further optionally 7000 cps to 20,000 cps, and further optionally 10,000 cps to 15,000 cps. Where the hot melt material is a polyamide, the viscosity thereof as it exits the dispensing gun module can be about 25,000 cps. Where the hot melt material is a polyolefin, the viscosity, thereof, as it exits the dispensing gun module can be about 18,000 cps to 25,000 cps. Of course, other viscosities can be selected depending on the particular application, the hot melt material, the rate of dispensing, the speed of the conveyor, the size of the washers and other physical or operating parameters.

Optionally, to keep the dispensing good modules operating properly, multiple components of the dispensing station 330 can be heated with a suitable heating element 331. This can ensure that the hot melt material flows through the components of the dispensing station without solidifying, coagulating, or otherwise plugging different components of the station, thereby inhibiting acceptable flow of the hot melt material through the system and ultimately out the dispensing gun modules toward the conveyor and apertures of the washers.

As shown in FIGS. 19-20, after the hot melt material has been dispensed by the dispensing station 330 onto each of the respective washers 380 passing thereby, those washers continue along the conveyor belt 371 toward the curing stations 350. The curing stations can include first 351 and second 352 cooling stations. These cooling stations can be configured to blow chilled air over the washers and the applied hot melt material to effectively cure that material, ensuring a strong bond with the surfaces (e.g., the inner diameter) of the washer. Alternatively, the cooling stations can be in the form of a water chilled system that exposes the surfaces of the washers and hot melt material directly to water, so that the water comes in direct contact with those surfaces. Other types of chilling systems using refrigerants and associated piping are also contemplated to effectively cure the hot melt material on the washers, ensuring well-formed retention aid bodies associated with the washers.

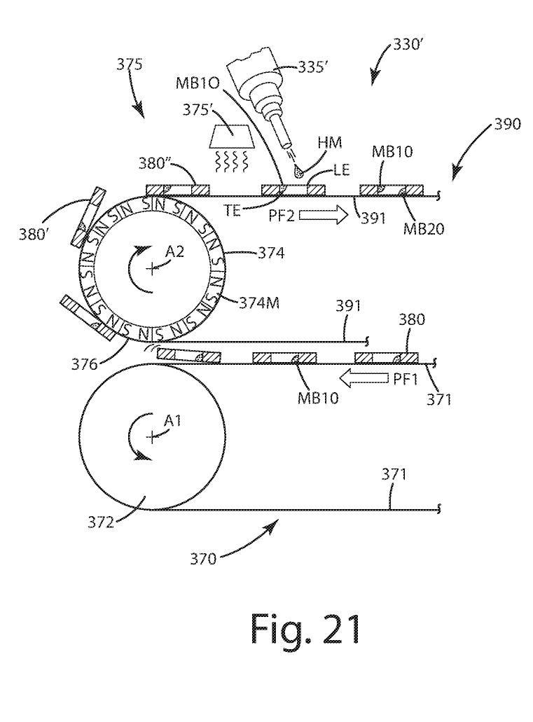

After the washers 380 pass the curing station 350, they continue along the first conveyor 370, toward the transfer station 375 as illustrated in FIG. 21 in the direction of the product flow PF1. The transfer station 375 can include roller 374, which rotates in a direction A2. The direction A2 can be the opposite of the direction of rotation A1 of the roller 372. The direction A1 can be counterclockwise, while the direction A2 can be clockwise. Of course, these directions can be reversed. Other rollers can also be included in the construction with different rotation of all directions associated with each.

When the individual washers 380 are constructed from ferromagnetic metals (in other cases they can be constructed from non-ferromagnetic materials, such as polymers, aluminum, brass and/or other non-ferromagnetic metals), those ferromagnetic washers are magnetically attracted via a magnetic force exerted by the roller 374 thereon. In particular, the magnetic elements 374M disposed on or within the roller 374 exert a magnetic field to attract the washers away from the belt 371 and into contact and direct engagement with the outer surface 376 of the roller 374, and/or the belt 371. In so doing, the magnetic elements 374M effectively hold the washers against the belt 391 of the second conveyor 390. While the washers are attracted to the magnetic elements 374M on the roller, they are effectively lifted off the belt 371 and transition in the direction A2 so that they come to rest on the second belt 391.

As the washers 380′ transition around an axis 374A of the roller 374, they are held close to the conveyor belt 391 and prevented from dropping vertically off of the apparatus. When the washers transition to the upper portion of the belt 391, they are effectively pried away from the magnetic force of the magnetic elements 374M of the roller 374. For example, washer 380″ moves along the upper portion of the belt 391 far enough so it is no longer magnetically attracted to the roller magnetic elements 374M. Thereafter, the washer continues in the direction of the product flow PF2 along the second conveyor 390.

As shown in FIG. 21, by the time the washers transition from the first belt 371 to the upper portion of the second belt 391, they have effectively been turned over or flipped upside down. In other words, what was previously the upper surface of the washer 380, when it was located on the belt 371, becomes the lower surface of the washer 380″ on the upper portion of the second belt 391. Thus, the transition station 375 effectively flips returns over the washers 180°. As can some be seen comparing the washers on the respective belts, the washers 380 on the belt 371 have a retention aid body MB10. This retention aid body MB10 is effectively on the trailing edge of the inner diameter of the washer 380 on the belt 371. When it transitions through the transition station 375 and comes to travel in the product flow PF2 on the upper portion of the belt 391, the retention aid body MB10 remains on the trailing edge of the inner diameter of the washer 380″, however, that retention aid body MB10 is effectively turned upside down relative to its position on the belt 371.

After the washers 380″ become disposed in the upper portion of the belt 391, the continue to travel in direction of product flow PF2. As they travel in that direction, they pass by a second dispensing station 330′, which is similar to the dispensing station 330 on the first conveyor 370. Optionally, they pass through a mild preheat station 375′ to slightly warm the washers before application of the hot melt material HM via the dispensing gun module 335′ at the second dispensing station 330′. Of course, the preheat station 375′ can be set up so that it does not substantially deform and/or melt the existing retention aid body MB10. In some cases, the curing station 350 on the first conveyor 370 can be eliminated so that the washers retain the heat applied in the first preheat station 375, in which case the second preheat station 375′ can be eliminated.

The hot melt material HM can be applied slightly differently to washers on the second conveyor 390 than the hot melt material applied on the first conveyor 370. For example, as shown in FIG. 21, the second application of hot melt material HM can be performed via a gun 335′ which is aimed toward the leading edge LE of the inner diameter of the aperture of the washer, rather than the trailing edge TE. This is because the retention aid body MB10 already exists at the trailing edge TE of the aperture, so there is no need to add another retention aid body over that already existing one. In effect, the hot melt material HM is shot toward the leading edge as the washer travels past the dispensing gun module. It engages the inner diameter of the aperture of the washer similar to the retention aid material of the embodiment shown in FIGS. 13-16. Thus, it can include the same features and components thereof, such as a body having a seepage portion and a free edge.

After the second amount of hot melt material HM is applied, the washer continues in the direction of product flow PF2 along the second conveyor belt 391. It then optionally passes second curing stations 350′. These curing stations can be cooling and/or chilling stations similar to the first stations 350 on the first conveyor 370. At the second curing station, chilled air and/or water can be projected over the washers and the recently applied hot melt material to cure it and fully bond it to the respective washers.

With the hot melt material cured and the two opposing retention aid material bodies MB10 and MB20 formed, the conveyor 390 continues to convey the washers toward an ejection shoot 396 at which the washers travel along yet another product flow path PF3. This product flow path PS3 can be generally perpendicular to the paths PF2 and PF1. Optionally, the finished washers can be dumped into bins and/or packages along this product flow path PF3.

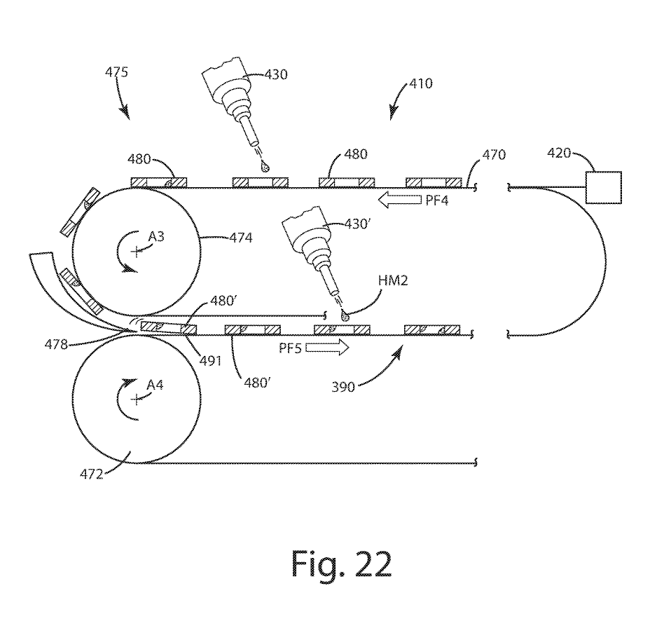

A fourth alternative embodiment of the apparatus and related method is illustrated in FIG. 22 and generally designated 410. This embodiment can be similar in structure, function and operation to the embodiments described above with several exceptions. For example, this embodiment optionally can be constructed to apply a hot melt material, or other liquid retention aid material, to an apertured part, such as a washer, that is non-ferromagnetic. For example, the washers processed by this apparatus 410 can be constructed from aluminum, brass, alloys, polymers, composites, and/or other non-ferromagnetic materials. Of course, in certain applications, the washers can be constructed from ferromagnetic materials.

Further, like the embodiment immediately above, the apparatus 410 can be set up to apply a type of retention aid material, for example, a hot melt adhesive, a polyamide, a polyolefin and/or PUR hot melt (all generally referred to herein as hot melt material), in liquid form, or some other liquid retention aid material to the non-ferromagnetic washers 480, at more than one location around an inner diameter of the washers 480. As an example, the apparatus 410 can construct washers similar to those shown in FIGS. 14-16 in the embodiment above.

The apparatus 410 can be further constructed similar to the embodiment described immediately above and shown in FIGS. 19-21, however, instead of having the first/lower, conveyor onto which the feed station feeds washers initially, in this apparatus 410, as shown in FIG. 22, the upper conveyor can instead be the conveyor onto which the feed station 420 feeds washers initially. The upper conveyor 470 in this embodiment conveys washers 480 in the direction of product flow PF4, whereas the second conveyor 490 conveys washers 480′ back in the opposite direction along product flow PF5. The respective rollers 474 and 472 of the respective first (upper) and second (lower) conveyors also can rotate in directions A3 and A4 respectively, which can be opposite the directions A2 and A1 of the embodiment shown in FIG. 22.

The first/upper conveyor 470 can include components and stations similar to the first conveyor 370 in the embodiment above, such as feed wheel, a preheat station, a material dispensing station 430, a curing station (not shown) and the like. As above, the dispensing station 430 can dispense a first amount of hot melt material in the aperture of the washer, generally along the inner diameter. After the hot melt material on this conveyor is dispensed, it can be cooled a curing station (not shown) and proceed to the end of the conveyor.

Because of the non-ferromagnetic material of the washers, the transfer station 475 of the apparatus 410 however, can be slightly different in the embodiment above. For example, in this embodiment, neither of the rollers 474 or 472 are constructed with magnetic elements to hold the washers 480 thereon as the washers are flipped over and redirected on the second conveyor 490. More particularly, the transfer station 475 can include a redirector plate 476 which can generally be in the form of a rounded plate about the width of the conveyor. This redirector plate 476 can be configured so that when the washers 480 fall off the end of the conveyor 470, they are directed toward a slot or channel 477 that is formed between the redirector plate 476 and the roller 474. The washers 480 slide through this channel which includes an exit end 478 that is disposed adjacent the belt 491 of the second conveyor 490. Accordingly, the washers 480′ can be ejected toward and/or drop onto the belt 491.

After being deposited on the belt 491, the second conveyor conveys the washers 480′ in the direction of product flow PF5. On the second conveyor 490, with the washers 480′ effectively flipped upside down relative to the washers 480 on the upper conveyor 470, another amount of hot melt material HM2 is dispensed via the dispensing gun 430′ on an opposing portion of the inner diameter of the washers 480′ Like the embodiment described immediately above, the washers 480′ can be conveyed through a curing station to cure and/or cool the hot melt material, thereby further bonding it to the respective washers. Further, the resulting washers with retention aid bodies produced by the apparatus 410 can be similar to the washers shown in FIGS. 14-16.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

The embodiments of the invention in which an exclusive property or privilege is claimed are defined as follows:

1. A method of applying a retention aid to an apertured part comprising:
feeding an apertured part onto a conveyor, the apertured part including an upper surface and a lower surface with an aperture extending between the upper surface and the lower surface, the apertured part including an inner diameter surface that faces generally toward an axis of the apertured part within the aperture;
moving with the conveyor the apertured part along a substantially horizontal pathway, the upper surface of the apertured part being parallel to a substantially horizontal plane that is parallel to the substantially horizontal pathway, the conveyor including an upper surface having an associated release agent;
dispensing a liquid retention aid material so that the liquid retention aid material enters the aperture as the apertured part moves along the substantially horizontal pathway;
colliding the liquid retention aid material against the upper surface of the conveyor and at least a portion of the inner diameter surface as the apertured part moves along a substantially horizontal pathway;
curing the liquid retention aid material so that it joins with the at least a portion of the inner diameter surface, thereby forming a retention aid projection that extends from the inner diameter surface toward the axis of the apertured part.

2. The method of claim 1,
wherein the aperture part is at least one of a washer and a collar,
wherein the lower surface is horizontal and in a horizontal plane when the apertured part is moved along the substantially horizontal pathway with the conveyor.

3. The method of claim 2,
wherein the liquid retention aid material is dispensed from a dispenser disposed above the conveyor,
wherein a trailing edge of the inner diameter surface collides with the liquid aid retention material in such a manner that the liquid aid retention material engages against and moves upwardly along the inner diameter surface, along the trailing edge.

4. The method of claim 1,
wherein the inner diameter surface includes a trailing edge, and
wherein the trailing edge operates as a backstop to engage the liquid aid retention material when the liquid aid retention material, in liquid form, enters the aperture during the colliding step.

5. The method of claim 1 comprising:
seeping the liquid aid retention material under the apertured part so that the liquid aid retention material engages the lower surface of the apertured part.

6. The method of claim 5 comprising:
engaging the liquid aid retention material with the inner diameter surface and the lower surface of the apertured part before the curing step.

7. The method of claim 1 comprising:
disposing a first plurality of N-S pole magnets on a first side of a centerline of the conveyor;
disposing a second plurality of N-S pole magnets on a second side of a centerline of the conveyor, opposite the first plurality of N-S pole magnets;
wherein each of the first plurality of magnets and the second plurality of magnets are oriented so that either a North pole or a South pole of each of the first plurality of magnets and the second plurality of magnets face toward the centerline and one another,
wherein the first plurality of magnets and the second plurality of magnets cooperatively generate a magnetic field to urge the apertured part toward the centerline of the conveyor due to the magnetic field.

8. The method of claim 1 comprising:
moving the apertured part linearly at least one of adjacent and on a centerline of the conveyor; and
pressing an outer diameter leading edge, and an inner diameter trailing edge past a dispenser, before the colliding step.

9. The method of claim 1,
wherein the liquid retention aid material is an ultraviolet light curable material,
wherein during said curing, light having a wavelength of 200 nm to 600 nm is projected on the liquid retention aid material.

10. The method of claim 1 comprising:
moving the apertured part with an adjustment guide extending adjacent the conveyor so as to move the apertured part relative to a centerline of the conveyor.

11. The method of claim 1 comprising:
engaging the apertured part with a metering wheel to space the apertured part at a preselected distance relative to another apertured part as the apertured part and the other apertured part are moved with the conveyor,
wherein the preselected distance enables the liquid retention aid material to be dispensed toward the apertured part and the other apertured part in a sequential manner.

12. The method of claim 1,
wherein the apertured part is a metal washer having a thickness between the upper surface and lower surface of less than ¼ inch,
wherein the conveyor includes a width spanning between first and second edges of the conveyor, and comprising:
orienting the metal washer at a preselected location between the first and second edges using a plurality of magnets disposed adjacent the conveyor as the metal washer moves linearly along the substantially horizontal pathway.

13. A method of applying a retention aid to an apertured part comprising:
moving a plurality of apertured parts linearly along a conveyor past a dispenser, each apertured part including an upper surface and a lower surface with an aperture extending between the upper surface and the lower surface, the apertured part including an inner diameter surface that faces generally toward an axis of the apertured part within the aperture;
dispensing a liquid retention aid material from the dispenser so that the liquid retention aid material engages the inner diameter surface as the plurality of apertured parts move linearly along the conveyor; and
curing the liquid retention aid material so that the material joins with the at least a portion of the inner diameter surface, thereby forming a retention aid projection that extends away from the inner diameter surface.

14. The method of claim 13 comprising:
seeping the liquid retention aid material under at least a portion of an apertured part from the plurality of apertured parts so that the liquid aid retention material engages the lower surface of the apertured part; and
forming a layer of the liquid retention aid.

15. The method of claim 13 wherein each of the plurality of aperture parts is a washer, comprising:
orienting the plurality of apertured parts vertically as they move linearly along the conveyor past the dispenser.

16. The method of claim 14 comprising:
dropping an amount of the liquid retention aid material in liquid form while the washer is vertically oriented, so that the liquid aid retention material engages a lower inner diameter surface, located under an outer diameter of the washer.

17. An apparatus adapted to apply a retention aid to an aperture part, the apparatus comprising:
a horizontal conveyor including a conveyor upper surface having a release agent;
a feed station located adjacent the horizontal conveyor and adapted to feed a plurality of apertured parts, each defining an aperture, onto the horizontal conveyor so that the apertured parts are conveyed with an upper surface of each apertured part being parallel to a substantially horizontal plane and facing upward, and a lower surface of each apertured part being parallel to the substantially horizontal plane and facing downward and engaging the conveyor upper surface;
a liquid retention aid material dispensing station located adjacent the horizontal conveyor, the liquid retention aid material dispensing station adapted to dispense liquid retention aid material in liquid form in a sequential manner so that an amount of retention aid material moves through air toward the conveyor and into the aperture of one of a plurality of apertured parts so as to engage an inner diameter surface of the aperture while the upper surface is parallel to the substantially parallel plane; and
a curing station located adjacent the horizontal conveyor, the curing station emitting at least one wavelength of light toward the apertured parts as the apertured parts are conveyed along the conveyor so as to solidify the amount of liquid retention aid material engaged with the inner diameter surface of the aperture and form a semi rigid retention tab that projects inwardly from the inner diameter surface of the aperture.

18. The apparatus of claim 17,
wherein the dispensing station includes a dispenser that dispenses the amount of liquid retention aid material in a timed manner so that the amount of liquid retention aid material is passed by an outer diameter leading edge and an inner diameter leading edge before the liquid retention aid material engages a trailing edge of the inner diameter surface as the respective apertured part moves under the dispenser.

19. The apparatus of claim 17 comprising:
an adjustment guide projecting over the conveyor, the adjustment guide adapted to bump each apertured part of the plurality of apertured parts when passing the adjustment guide so as to move the respective apertured parts toward or away from a centerline of the conveyor.

20. An apertured part including a retention aid comprising:
a part body comprising:
an upper surface;
a lower surface disposed opposite the upper surface;
an outer circumferential edge forming an outer boundary of at least one of the upper surface and the lower surface;
an inner circumferential edge forming an inner boundary of at least one of the upper surface and the lower surface, the inner circumferential edge bounding an aperture defined by and extending between the upper surface and the lower surface, the aperture including an aperture axis corresponding to a center of the aperture; and
a retention aid body constructed from a polymeric material, the retention aid body joined with the inner circumferential edge, the retention aid body extending inward toward the aperture axis a preselected distance, the resilient retention aid body including a free end that is adapted to flex and engage a complimentary part inserted through the aperture,
wherein the resilient retention aid body at least one of:
curved along a length of the free end when viewed from a top view of the washer, and
includes a seepage portion that extends outwardly, beyond the inner circumferential edge toward the outer circumferential edge, the seepage portion being joined with the lower surface of the apertured part.
